(19) United States
(12) Patent Application Publication
(10) Pub. No.: US 2026/0319392 A1
(43) Pub. Date: Oct. 15, 2026

(54) ELECTROPHOTOGRAPHIC PHOTORECEPTOR, ELECTROPHOTOGRAPHIC PHOTORECEPTOR CARTRIDGE, AND IMAGING DEVICE

(71) Applicant: MITSUBISHI CHEMICAL CORPORATION, Tokyo (JP)

(72) Inventors: Akira ANDO, Tokyo (JP); Takahito MAKINOUCHI, Tokyo (JP)

(73) Assignee: MITSUBISHI CHEMICAL CORPORATION, Tokyo (JP)

(21) Appl. No.: 19/343,698

(22) Filed: Sep. 29, 2025

Related U.S. Application Data
(63) Continuation of application No. PCT/JP2024/012661, filed on Mar. 28, 2024.

(30) Foreign Application Priority Data
Mar. 29, 2023 (JP) 2023-052591

(51) Int. Cl. G03G 5/147; C08F 4/00

(52) U.S. Cl. CPC G03G 5/14769; C08F 4/00; G03G 5/14704; G03G 2215/00957; G03G 2215/00962

(57) ABSTRACT

The present disclosure relates to an electrophotographic photoreceptor including a photosensitive layer and a protective layer sequentially on an electroconductive support, the electrophotographic photoreceptor having a high Martens hardness and a high elastic deformation rate on a surface of the photoreceptor and being capable of suppressing image deletion.

### TECHNICAL FIELD

The present disclosure relates to an electrophotographic photoreceptor used in a copying machine, a printer, or the like, and an electrophotographic photoreceptor cartridge and an image forming apparatus, each of which includes the electrophotographic photoreceptor.

### BACKGROUND ART

In a printer, a copying machine, or the like, when a charged organic photoconductor (OPC) drum is irradiated with light, the irradiated portion undergoes electrostatic elimination to generate an electrostatic latent image, and a toner is attached to the electrostatic latent image, whereby an image can be obtained. In an instrument using the electrophotographic technology, the photoreceptor is a key member.

Since this type of organic photoconductor affords much room for material selection and the properties of the photoreceptor are easily controlled, a “function-separated photoreceptor” in which the functions of charge generation and charge transfer are shared by different compounds has become the mainstream. For example, a single-layer type electrophotographic photoreceptor having a charge generation material (CGM) and a charge transport material (CTM) in the same layer (hereinafter referred to as single-layer type photoreceptor), and a laminated type electrophotographic photoreceptor obtained by laminating a charge generation layer containing a charge generation material (CGM) and a charge transport layer containing a charge transport material (CTM) (hereinafter referred to as laminated type photoreceptor) are known. Examples of a charging method for the photoreceptor include a negative charging method of charging the surface of the photoreceptor with a negative charge and a positive charging method of charging the surface of the photoreceptor with a positive charge.

Examples of currently practically used combinations of the layer structure and the charging method for the photoreceptor include a “negatively charged laminated type photoreceptor” and a “positively charged single-layer type photoreceptor.”

The “negatively charged laminated type photoreceptor” generally has a configuration in which an undercoat layer (UCL) made of a resin or the like is provided on an electroconductive substrate such as an aluminum tube; a charge generation layer (CGL) made of a charge generation material (CGM), a resin, and the like is provided thereon; and a charge transport layer (CTL) made of a hole transport material (HTM), a resin, and the like is further provided thereon.

Meanwhile, the “positively charged single-layer type photoreceptor” generally has a configuration in which an undercoat layer (UCL) made of a resin or the like is provided on an electroconductive substrate, such as an aluminum tube, and a single-layer type photosensitive layer made of a charge generation material (CGM), a hole transport material (HTM), an electron transport material (ETM), a resin, and the like is provided thereon (e.g., see Patent Literature 1).

In any of the photoreceptors, the surface of the photoreceptor is charged by a corona discharge method or a contact method, and then the photoreceptor is exposed to light to neutralize the surface charge, thereby forming an electrostatic latent image by a potential difference from the surrounding surface. Thereafter, a toner is brought into contact with the surface of the photoreceptor to form a toner image corresponding to the electrostatic latent image, and the toner image is transferred onto paper or the like and is then heated, molten, and fixed to complete printing.

As described above, the electrophotographic photoreceptor has a basic configuration in which a photosensitive layer is formed on an electroconductive support, but a protective layer is also provided on the photosensitive layer for the purpose of improving abrasion resistance and the like.

As a technique for improving the mechanical strength or abrasion resistance of the surface of a photoreceptor, there is disclosed a photoreceptor in which a protective layer containing a compound having a chain-polymerizable functional group is formed as an outermost layer of the photoreceptor, and energy such as heat, light, or radiation is applied to the layer to polymerize the compound, thereby forming a cured resin layer (e.g., see Patent Literatures 1 and 2).

As a highly sensitive photoinitiator used in such a protective layer, particularly in a photocurable protective layer, a compound having an oxime ester structure is known (e.g., see Patent Literatures 3, 4, and 5). Among initiators having an oxime ester structure, a compound having a carbazole skeleton exhibits high sensitivity.

### CITATION LIST

### Patent Literature

Patent Literature 1: U.S. Pat. No. 9,417,538
Patent Literature 2: WO 2010/035683 (JP 5263296 B)
Patent Literature 3: JP 2008-216297 A
Patent Literature 4: JP 2018-13676 A
Patent Literature 5: JP 2020-99008 A

### SUMMARY

### Technical Problem

However, it has been found that when a known initiator having an oxime ester structure is used as described above, image deletion (image blurring) tends to occur.

An object of the present disclosure is to provide a novel electrophotographic photoreceptor including a photosensitive layer and a protective layer sequentially on an electroconductive support, the electrophotographic photoreceptor having a high Martens hardness and a high elastic deformation rate on a surface of the photoreceptor and being capable of suppressing image deletion, and an electrophotographic photoreceptor cartridge and an image forming apparatus, each of which includes the electrophotographic photoreceptor.

### Solution to Problem

In order to solve the above-described problems, the gist of the present disclosure exists in the following [1] to [18].

[1] An electrophotographic photoreceptor including a photosensitive layer and a protective layer sequentially on an electroconductive support, wherein
the protective layer contains a polymer having a structure represented by Formula (1) described below.

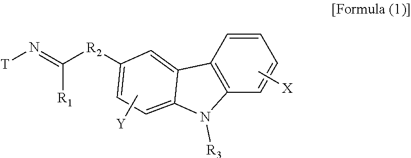

In Formula (1), R₁ represents an organic group having 2 or more carbons; R₂ represents a single bond or a carbonyl group; X, Y, and R₃ each independently represent any substituent; and T represents a bond with any atom.

[2] The electrophotographic photoreceptor according to [1], wherein the protective layer contains a polymer having a structure represented by Formula (2) described below.

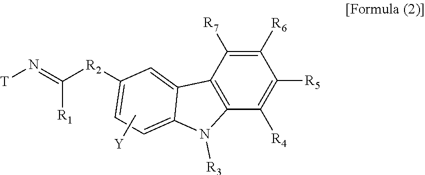

In Formula (2), R₁ represents an organic group having 2 or more carbons; R₂ represents a single bond or a carbonyl group; R₃, R₄, R₅, R₆, and R₇ each independently represent a hydrogen atom, a halogen atom, a nitro group, an acyl group optionally having a substituent, an alkyl group having from 1 to 20 carbons and optionally having a substituent, or an aryl group optionally having a substituent, and may be bonded together and have a cyclic structure; Y represents a hydrogen atom, a halogen atom, a nitro group, an acyl group optionally having a substituent, an alkyl group having from 1 to 20 carbons and optionally having a substituent, or an aryl group optionally having a substituent; and T represents a bond with any atom.

[3] An electrophotographic photoreceptor including a photosensitive layer and a protective layer sequentially on an electroconductive support, wherein
the protective layer contains a polymer of a compound represented by Formula (3) described below.

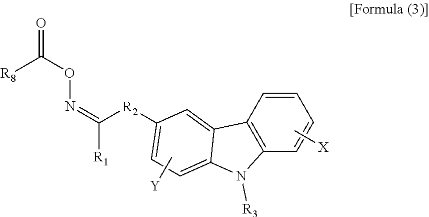

In Formula (3), R₁ represents an organic group having 2 or more carbons; R₂ represents a single bond or a carbonyl group; and X, Y, R₃, and R₈ each independently represent any substituent.

[4] The electrophotographic photoreceptor according to [3], wherein the protective layer contains a polymer of a compound represented by Formula (4) described below:

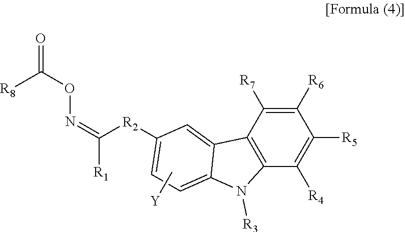

In Formula (4), R₁ represents an organic group having 2 or more carbons; R₂ represents a single bond or a carbonyl group; R₃, R₄, R₅, R₆, and R₇ each independently represent a hydrogen atom, a halogen atom, a nitro group, an acyl group optionally having a substituent, an alkyl group having from 1 to 20 carbons and optionally having a substituent, or an aryl group optionally having a substituent, and may be bonded together and have a cyclic structure; Y represents a hydrogen atom, a halogen atom, a nitro group, an acyl group optionally having a substituent, an alkyl group having from 1 to 20 carbons and optionally having a substituent, or an aryl group optionally having a substituent; and R₈ represents a hydrogen atom, a halogen atom, an alkyl group having from 1 to 20 carbons and optionally having a substituent, or an aryl group optionally having a substituent.

[5] The electrophotographic photoreceptor according to [2] or [4], wherein at least one of R₃, R₄, R₅, R₆, or R₇ is an acyl group optionally having a substituent.

[6] The electrophotographic photoreceptor according to [5], wherein the acyl group optionally having a substituent is a structure represented by Formula (5).

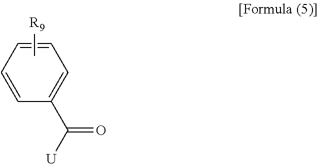

In Formula (5), R₉ represents a hydrogen atom, a halogen atom, a nitro group, an acyl group optionally having a substituent, an alkyl group having from 1 to 20 carbons and optionally having a substituent, or an aryl group optionally having a substituent; when two or more Ros are present, they may be bonded together and have a cyclic structure; and U represents a bond with nitrogen to which R₃ is bonded or with carbon to which any of R₄, R₅, R₆, and R₇ is bonded.

[7] The electrophotographic photoreceptor according to any one of [1] to [6], wherein the protective layer has a chain-polymerizable functional group.

[8] The electrophotographic photoreceptor according to [7], wherein the chain-polymerizable functional group is an acryloyloxy group or a methacryloyloxy group.

[9] The electrophotographic photoreceptor according to [2], [4], [5], or [6], wherein R₆ is the structure represented by Formula (5).

[10] The electrophotographic photoreceptor according to any one of [1] to [9], wherein the organic group of R₁ is an acyl group optionally having a substituent, an alkyl group optionally having a substituent, or an aryl group optionally having a substituent.

[11] The electrophotographic photoreceptor according to any one of [1] to [9], wherein R₁ is one structure selected from the group consisting of structures represented by Formulae (6) to (8) described below.

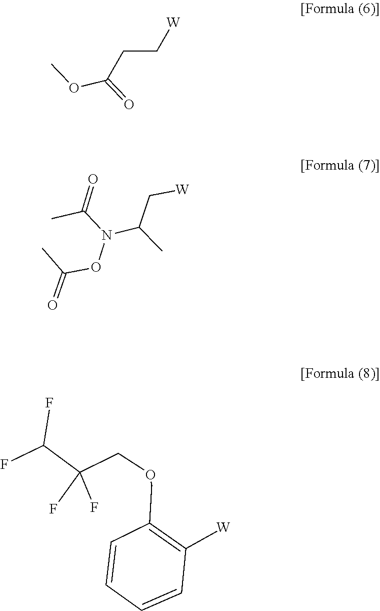

In Formula (6), Formula (7), and Formula (8), W represents a bond with carbon to which R₁ is bonded.

[12] The electrophotographic photoreceptor according to any one of [1] to [11], wherein R₃ is an alkyl group having from 1 to 20 carbons and optionally having a substituent.

[13] The electrophotographic photoreceptor according to any one of [1] to [11], wherein the protective layer contains metal oxide particles.

[14] The electrophotographic photoreceptor according to [13], wherein the metal oxide particles are titanium oxide.

[15] The electrophotographic photoreceptor according to [13], wherein the protective layer contains the structure represented by Formula (1) or the structure represented by Formula (3) in a proportion of 0.03 mol % or more and 2 mol % or less per 100 mol % of the metal oxide particles in the protective layer.

[16] The electrophotographic photoreceptor according to any one of [1] to [15], wherein the photosensitive layer is a single-layer type photosensitive layer.

[17] An electrophotographic photoreceptor cartridge including the electrophotographic photoreceptor described in any one of [1] to [16].

[18] An image forming apparatus including the electrophotographic photoreceptor described in any one of [1] to [16].

### Advantageous Effects

The electrophotographic photoreceptor of the present disclosure has a high Martens hardness and a high elastic deformation rate on the surface of the photoreceptor and can also suppress image deletion.

### BRIEF DESCRIPTION OF DRAWINGS

FIG. 1 is a schematic view of an example of a configuration of an image forming apparatus that can be constituted using an electrophotographic photoreceptor according to an embodiment of the present disclosure.

FIG. 2 is a graph showing a general relationship between an indentation depth of an indenter and a load curve when the Martens hardness and elastic deformation rate of a photoreceptor are measured.

### DESCRIPTION OF EMBODIMENTS

Next will be described an embodiment for carrying out the present disclosure (hereinafter referred to as “embodiment of the present disclosure”) in detail. The present disclosure is not limited to the following embodiments and can be carried out with various modifications within the scope of the gist thereof.

### Present Electrophotographic Photoreceptor

An electrophotographic photoreceptor according to an exemplary embodiment of the present disclosure (hereinafter also referred to as “the present electrophotographic photoreceptor”) is an electrophotographic photoreceptor including a photosensitive layer and a protective layer sequentially on an electroconductive support, wherein the protective layer preferably contains a cured product obtained by curing a curable compound.

The present electrophotographic photoreceptor may optionally have a layer other than the photosensitive layer and the protective layer.

A charging method for the present electrophotographic photoreceptor may be either a negative charging method of charging the surface of the photoreceptor with a negative charge or a positive charging method of charging the surface of the photoreceptor with a positive charge.

In the present electrophotographic photoreceptor, a side opposite to the electroconductive support is an upper side or a front surface side, and an electroconductive support side is a lower side or a back surface side. From the viewpoint of further achieving the effects of the present disclosure, the protective layer is preferably an outermost layer.

### Present Protective Layer

The protective layer of the present electrophotographic photoreceptor (also referred to as “the present protective layer”) preferably contains a polymer having a structure represented by Formula (1) described below, and more preferably has a structure represented by Formula (2) described below.

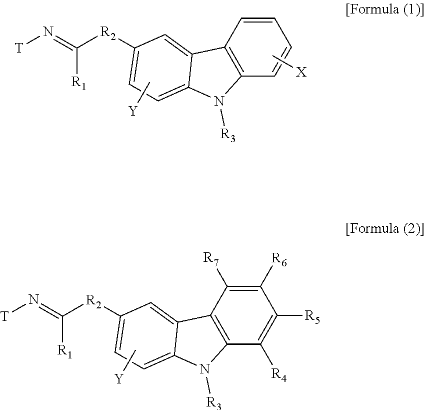

An example of the case where the present protective layer has a structure represented by Formula (1) or (2) can be an example where the present protective layer contains a polymer of a compound represented by Formula (3) or (4), described below. That is, the compound represented by Formula (3) or (4), described below, functions as a polymerization initiator, and thus, for example, when a curable compound described below is cured, in other words, when a curable compound described below is crosslinked, a polymer is formed so that the compound represented by Formula (3) or (4), described below, is incorporated into a portion of the crosslinked structure, and the polymer has the structure represented by Formula (1) or (2). It is considered that the use of the compound represented by Formula (3) or (4), described below, as a polymerization initiator increases radical generation efficiency and allows a polymerization reaction to sufficiently proceed, and thus increases the Martens hardness and elastic deformation rate of the surface of the photoreceptor.

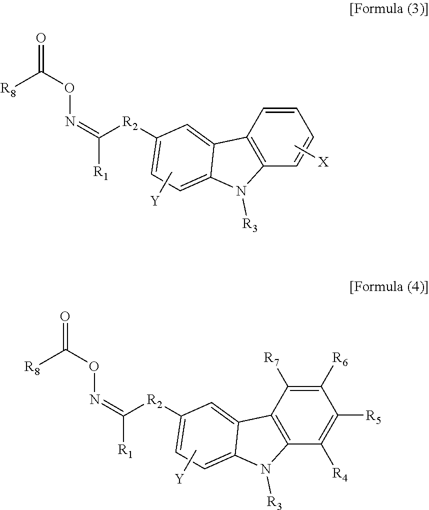

In Formulae (1) to (4), R₁ represents an organic group having 2 or more carbons. Especially, from the viewpoint of serving as a steric hindrance and suppressing image deletion, an organic group having 3 or more carbons is preferable, an organic group having 4 or more carbons is more preferable, an organic group having 7 or more carbons is still more preferable, and an organic group having 9 or more carbons is yet still more preferable.

Examples of the organic group include an acyl group optionally having a substituent, an alkyl group optionally having a substituent, and an aryl group optionally having a substituent. Among these, an aryl group optionally having a substituent is preferable from the viewpoint of being effective as a steric hindrance.

The structure of R₁ can be, for example, one structure selected from the group consisting of structures represented by Formulae (6) to (8) described below. Among these, from the viewpoint of steric hindrance, Formula (7) or Formula (8) is preferable, and Formula (8) is more preferable.

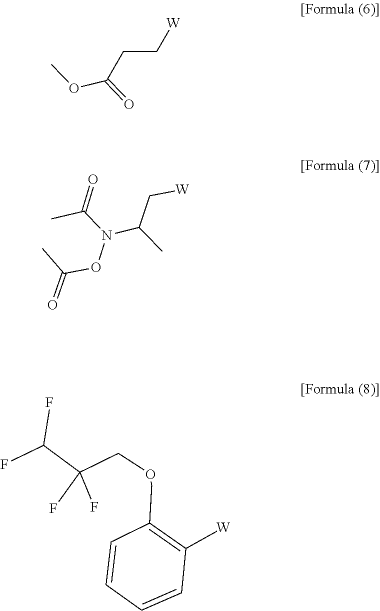

In Formula (6), Formula (7), and Formula (8), W represents a bond with carbon to which R₁ is bonded.

In Formulae (1) to (4), R₂ represents a single bond or a carbonyl group. Of these, a single bond is preferable from the viewpoint of the stability of the compound.

In Formula (1) and Formula (3), X, Y, and R₃ do not affect a steric hindrance around an oxime ester site and therefore may be optional substituents. From the viewpoint of preventing influence on particle dispersion, X, Y, and R₃ are preferably nonpolar substituent. Preferably, the nonpolar substituents are each independently a hydrogen atom, a halogen atom, a nitro group, an acyl group optionally having a substituent, an alkyl group having from 1 to 20 carbons and optionally having a substituent, or an aryl group optionally having a substituent. The optional substituents may be bonded together and have a cyclic structure.

In Formula (2) and Formula (4), R₃, R₄, R₅, R₆, and R₇ each independently represent a hydrogen atom, a halogen atom, a nitro group, an acyl group optionally having a substituent, an alkyl group having from 1 to 20 carbons and optionally having a substituent, or an aryl group optionally having a substituent, and may be bonded together and have a cyclic structure.

Among them, at least one of R₃, R₄, R₅, R₆, or R₇ is preferably an acyl group optionally having a substituent from the viewpoint of reactivity. Especially, R₆ is more preferably an acyl group optionally having a substituent.

The acyl group optionally having a substituent is preferably a structure represented by Formula (5) from the viewpoint of reactivity. Especially, from the viewpoint of reactivity, R₆ is still more preferably the structure represented by Formula (5).

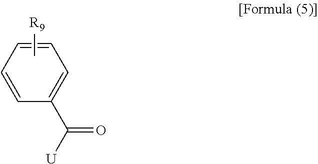

In Formula (5), R₉ represents a hydrogen atom, a halogen atom, a nitro group, an acyl group optionally having a substituent, an alkyl group having from 1 to 20 carbons and optionally having a substituent, or an aryl group optionally having a substituent. When two or more Ros are present, they may be bonded together and have a cyclic structure.

U represents a bond with nitrogen to which R₃ is bonded or with carbon to which any of R₄, R₅, R₆, and R₇ is bonded.

In the present disclosure, the expression “a group optionally having a substituent” means that the group may have a substituent, and the meaning thereof encompasses both a case where the group has a substituent and a case where the group does not have a substituent.

The term “substituent” as used herein means any atom or atomic group that can be replaced with a hydrogen atom in the structure. Examples of the substituent include a halogen atom, a hydroxy group, an alkyl group, an alkoxy group, an acyl group, a carboxy group, an aryl group, a phenyl group, an amino group, an amide group, a nitro group, a cyano group, and a thiol group. In a case where the group has a substituent, the substituent is preferably an alkyl group.

In Formula (2) and Formula (4), Y each independently represents a hydrogen atom, a halogen atom, a nitro group, an acyl group optionally having a substituent, an alkyl group having from 1 to 20 carbons and optionally having a substituent, or an aryl group optionally having a substituent.

In Formula (1) and Formula (2), T represents a bond to any atom. The T represents a bond with a structure of a counterpart with which the compound represented by Formula (2) is polymerized.

In Formula (3), R₈ represents any substituent. R₈ in Formula (4) represents a hydrogen atom, a halogen atom, an alkyl group having from 1 to carbons and optionally having a substituent, or an aryl group optionally having a substituent.

Among these, R₈ is preferably an alkyl group having from 1 to 20 carbon atoms and optionally having a substituent, from the viewpoint of 20 reactivity. Especially, an alkyl group having from 1 to 6 carbons is preferable, an alkyl group having from 1 to 3 carbons is more preferable, and an alkyl group having 1 carbon (e.g., a methyl group) is still more preferable.
Metal Oxide Particles

The present protective layer preferably contains metal oxide particles from the viewpoint of imparting charge transport ability and from the viewpoint of improving mechanical strength.

When the protective layer contains metal oxide particles together with a known polymerization initiator having an oxime ester structure, the metal oxide particles tend to aggregate to cause image deletion. It is presumed that the oxime ester site of the polymerization initiator is adsorbed onto the surfaces of the metal oxide particles, thereby suppressing electrostatic repulsion between the metal oxide particles and causing aggregation, resulting in occurrence of image deletion.

In contrast, when the compound having an oxime ester structure having the substituent R₁ described above is used as the polymerization initiator as in the present disclosure, the substituent R₁ serves as a steric hindrance and inhibits adsorption of the oxime ester site onto the surfaces of the metal oxide particles, and thus the aggregation of the metal oxide particles is suppressed, whereby the occurrence of image deletion can be suppressed.

The metal oxide particles to be used can be metal oxide particles usable for an electrophotographic photoreceptor.

Examples of the metal oxide particles include particles of a metal oxide containing one type of metal element, such as titanium oxide, tin oxide, aluminum oxide, silicon oxide, zirconium oxide, indium oxide, zinc oxide, or iron oxide, and particles of a metal oxide containing a plurality of metal elements, such as indium tin oxide, calcium titanate, strontium titanate, and barium titanate. Only one type of metal oxide particles may be used, or a plurality of types of metal oxide particles may be mixed and used.

Among these metal oxide particles, metal oxide particles having a band gap of from 2 to 4 eV are preferably used, from the viewpoint of image deletion. Examples of the metal oxide particles having a band gap of from 2 to 4 eV include particles of a metal oxide containing one type of metal element, such as titanium oxide, tin oxide, indium oxide, zinc oxide, or iron oxide, and particles of a metal oxide, such as indium tin oxide, calcium titanate, strontium titanate, or barium titanate.

Among these metal oxide particles, titanium oxide, tin oxide, indium tin oxide, and zinc oxide are preferable, and titanium oxide or tin oxide are more preferable from the viewpoint of an electron transporting property. Of these, titanium oxide is particularly preferable from the viewpoint that image deletion suppression and electrical characteristics are easily balanced.

The crystal form of the titanium oxide particles may be any of rutile, anatase, brookite, and amorphous forms. The titanium oxide particles may include those having a plurality of different crystalline states among these crystalline states.

The surfaces of the metal oxide particles may be subjected to any type of surface treatment. For example, the surfaces may be treated with an inorganic substance, such as tin oxide, aluminum oxide, antimony oxide, zirconium oxide, or silicon oxide, or an organic substance, such as stearic acid, polyol, or an organosilicon compound. In particular, in the case of using titanium oxide particles, the particles are preferably surface treated with an organosilicon compound.

Examples of the organosilicon compound include silicone oils, such as dimethylpolysiloxane and methylhydrogenpolysiloxane; organosilanes, such as methyldimethoxysilane and diphenyldimethoxysilane; silazanes, such as hexamethyldisilazane; and silane coupling agents, such as 3-methacryloyloxypropyltrimethoxysilane, 3-acryloyloxypropyltrimethoxysilane, vinyltrimethoxysilane, γ-mercaptopropyltrimethoxysilane, and γ-aminopropyltriethoxysilane. In particular, from the viewpoint of improving the mechanical strength of the present protective layer, 3-methacryloyloxypropyltrimethoxysilane, 3-acryloyloxypropyltrimethoxysilane, and vinyltrimethoxysilane, all of which have a chain-polymerizable functional group, are preferable.

Before being treated with the treatment agent, the outermost surfaces of the surface-treated particles may be treated with a treatment agent such as aluminum oxide, silicon oxide, or zirconium oxide.

The metal oxide particles have an average primary particle size of preferably 500 nm or less, more preferably 100 nm or less, and still more preferably 50 nm or less. The average primary particle size is more preferably 1 nm or more, and still more preferably 5 nm or more.

The average primary particle size can be determined from an arithmetic average value of the particle sizes directly observed with a transmission electron microscope (hereinafter also referred to as TEM).

From the viewpoint of electrical characteristics, the content of the metal oxide particles in the present protective layer is preferably 20 parts by mass or more, more preferably 60 parts by mass or more, and still more preferably 80 parts by mass or more, per 100 parts by mass of the polymer contained in the present protective layer. Meanwhile, from the viewpoint of maintaining the surface charge, the content is preferably 200 parts by mass or less, more preferably 160 parts by mass or less, and still more preferably 120 parts by mass or less.

In a case where the present protective layer contains metal oxide particles, the content of the structure represented by Formula (1) is preferably 0.03 mol % or more and 2 mol % or less per 100 mol % of the metal oxide particles in the present protective layer.

The content of the structure represented by Formula (1) is preferably 0.03 mol % or more per 100 mol % of the metal oxide particles from the viewpoint of forming a cured film having high hardness. From such a viewpoint, the content of the structure represented by Formula (1) is more preferably 0.1 mol % or more, more preferably 0.3 mol % or more, and still more preferably 0.6 mol % or more.

Meanwhile, the content of the structure represented by Formula (1) is preferably 2 mol % or less per 100 mol % of the metal oxide particles from the viewpoint of favorable electrical characteristics. From such a viewpoint, the content of the structure represented by Formula (1) is more preferably 1.5 mol % or less, more preferably 1.2 mol % or less, and still more preferably 1 mol % or less.

### Additional Material

The present protective layer may contain an additional material, as necessary, in addition to the above-described materials. As the additional material, for example, from the viewpoint of enhancing the charge transport ability, a “charge transport material” may be contained, and, as necessary, an “additional polymerization initiator” different from the compound represented by Formula (3) or (4) may be contained. Further, as necessary, for example, a stabilizer (a heat stabilizer, an ultraviolet absorber, a light stabilizer, an antioxidant, or the like), a dispersant, an antistatic agent, a colorant, a lubricant, or the like may be contained. One type of these materials may be appropriately used alone, or two or more types thereof may be used in any proportions and in any combination.

### Charge Transport Material

As the aforementioned charge transport material, i.e., the charge transport material contained in the present protective layer, the same charge transport material as that used in the present photosensitive layer described below, can be used.

From the viewpoint of improving the Martens hardness of the surface of the photoreceptor, it is preferable that the protective layer contains a structure obtained by polymerizing a charge transport material having a chain-polymerizable functional group, so that the present protective layer has the chain-polymerizable functional group.

Examples of the chain-polymerizable functional group of the charge transport material having a chain-polymerizable functional group include an acryloyl group, an acryloyloxy group, a methacryloyl group, a methacryloyloxy group, a vinyl group, and an epoxy group. Among these, an acryloyl group, an acryloyloxy group, a methacryloyl group, or a methacryloyloxy group is preferable from the viewpoint of curability. The structure of the charge transport material moiety of the charge transport material having a chain-polymerizable functional group is preferably a carbazole derivative, an arylamine derivative, a stilbene derivative, a butadiene derivative, or an enamine derivative, and a structure in which a plurality of types of these compounds are bonded.

The content of the charge transport material in the protective layer of the present electrophotographic photoreceptor is not particularly limited. From the viewpoint of electrical characteristics, the content is preferably 100 parts by mass or more, more preferably 300 parts by mass or more, and still more preferably 500 parts by mass or more, per 100 parts by mass of the compound represented by Formula (3) or Formula (4). The content is more preferably 5000 parts by mass or less, more preferably 3000 parts by mass or less, and still more preferably 2000 parts by mass or less, from the viewpoint of retaining favorable surface resistance.

### Polymerization Initiator

Since the compound represented by Formula (3) or Formula (4) serves as a photopolymerization initiator, particularly a photopolymerization initiator that generates radicals by light irradiation, a polymerization initiator other than the compound represented by Formula (3) or Formula (4) (referred to as “additional polymerization initiator”) is not necessarily contained, but an “additional polymerization initiator” may be contained as necessary.

In this case, examples of the “additional polymerization initiator” include a thermal polymerization initiator and a photopolymerization initiator.

Examples of the thermal polymerization initiator include peroxide-based compounds, such as 2,5-dimethylhexane-2,5-dihydroperoxide, and azo-based compounds, such as 2,2′-azobis(isobutyronitrile).

The photopolymerization initiator can be classified into a direct cleavage type and a hydrogen abstraction type depending on the difference in radical generation mechanism.

Examples of the direct cleavage type photopolymerization initiator include acetophenone-based or ketal-based compounds, such as acetophenone, 2-benzoyl-2-propanol, 1-benzoylcyclohexanol, 2,2-diethoxyacetophenone, benzyl dimethyl ketal, and 2-methyl-4′-(methylthio)-2-morpholinopropiophenone; benzoin ether-based compounds, such as benzoin, benzoin methyl ether, benzoin ethyl ether, benzoin isobutyl ether, benzoin isopropyl ether, and O-tosylbenzoin; and acylphosphine oxide-based compounds, such as diphenyl(2,4,6-trimethylbenzoyl)phosphine oxide, phenyl bis(2,4,6-trimethylbenzoyl)phosphine oxide, and lithium phenyl (2,4,6-trimethylbenzoyl)phosphonate.

Examples of the hydrogen abstraction type photopolymerization initiator include benzophenone-based compounds, such as benzophenone, 4-benzoylbenzoic acid, 2-benzoylbenzoic acid, methyl 2-benzoylbenzoate, methyl benzoylformate, benzyl, p-anisyl, 2-benzoylnaphthalene, 4,4′-bis(dimethylamino)benzophenone, 4,4′-dichlorobenzophenone, and 1,4-dibenzoylbenzene; and anthraquinone-based or thioxanthone-based compounds, such as 2-ethylanthraquinone, 2-isopropylthioxanthone, 2-chlorothioxanthone, 2,4-dimethylthioxanthone, 2,4-diethylthioxanthone, and 2,4-dichlorothioxanthone. Examples of other photopolymerization initiators include camphorquinone, 1-phenyl-1,2-propanedione-2-(o-ethoxycarbonyl) oxime, acridine-based compounds, triazine-based compounds, and imidazole-based compounds.

In order to efficiently absorb light energy and generate a radical, the photopolymerization initiator preferably has an absorption wavelength in a wavelength region of a light source used for light irradiation.

From the viewpoint of preventing a decrease in radical generation efficiency, an acylphosphine oxide-based compound having an absorption wavelength on a relatively long wavelength side is preferably contained among the photopolymerization initiators.

In this case, from the viewpoint of supplementing the curability of the surface of the protective layer, it is more preferable to use an acylphosphine oxide-based compound and a hydrogen abstraction type initiator in combination. The content of the hydrogen abstraction type initiator relative to the acylphosphine oxide-based compound is not particularly limited. For example, the hydrogen abstraction type initiator is preferably contained in a proportion of 0.1 parts by mass or more from the viewpoint of supplementing surface curability, and is preferably contained in a proportion of 5 parts by mass or less from the viewpoint of maintaining internal curability, per 1 part by mass of the acylphosphine oxide-based compound.

A compound having a photopolymerization promoting effect may be used alone or in combination with the photopolymerization initiator. Examples of the compound having a photopolymerization promoting effect include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

One type of the polymerization initiator may be used, or two or more types thereof may be used in combination. The content of the polymerization initiator is preferably from 0.5 to 40 parts by mass, and more preferably 1 part by mass or more or 20 parts by mass or less, per 100 parts by mass of the total content of products having radical polymerizability.

It can be determined by, for example, thermally decomposing the present protective layer and using GC-MS or the like that the present protective layer has the structure represented by Formula (1) or Formula (2) and that the present protective layer contains a polymer of the compound represented by Formula (3) or Formula (4).

The content of each component contained in the present protective layer can also be measured by, for example, thermally decomposing the present protective layer and using GC-MS or the like.

Specifically, when signals derived from structures of Formulae (9) to (18) described below can be detected by pyrolysis GC-MS analysis, it can be determined that the protective layer has the structure represented by Formula (1) or Formula (2), or has a polymer of the compound represented by Formula (3) or Formula (4).

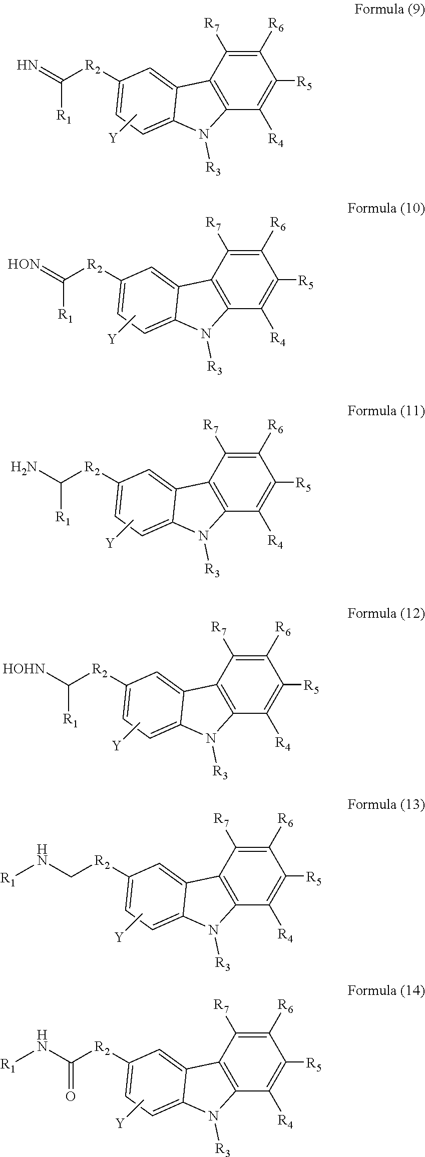

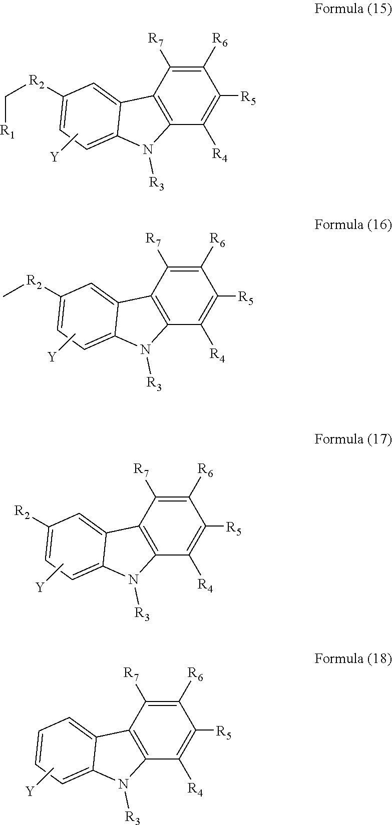

### Method for Forming Present Protective Layer

Next, a method for forming the present protective layer will be described.

The method for forming the present protective layer is not particularly limited. For example, the present protective layer can be formed by applying a coating liquid in which a curable compound described below, the metal oxide particles as necessary, the additional polymerization initiator as necessary, the charge transport material, and additional materials as necessary, together with the compound having the structure represented by Formula (3) or Formula (4), are dissolved in a solvent or dispersed in a dispersion medium (the coating liquid will be referred to as “coating liquid for forming the present protective layer”) onto the present photosensitive layer, and curing the coating liquid.

### Curable Compound

The curable compound can be, for example, a monomer, oligomer, or polymer having a chain-polymerizable functional group. Among these, a curable compound having crosslinkability, particularly a photocurable compound, is preferable. Examples of the compound include a curable compound having two or more chain-polymerizable functional groups. A compound having one chain-polymerizable functional group may be used in combination. Thus, when a curable compound having a chain-polymerizable functional group is used, the present protective layer can also be made to have a chain-polymerizable functional group.

Examples of the chain-polymerizable functional group include an acryloyl group, an acryloyloxy group, a methacryloyl group, a methacryloyloxy group, a vinyl group, and an epoxy group. Among these, an acryloyl group, an acryloyloxy group, a methacryloyl group, or a methacryloyloxy group is preferable, and an acryloyloxy group or a methacryloyloxy group is more preferable.

Among the curable compounds, a polyfunctional acrylate or a polyfunctional methacrylate is preferable from the viewpoint of curability.

Among these, from the viewpoint of having high resistance to an acidic gas or the like and being capable of suppressing occurrence of image deletion in a case where printing is repeated, a polyfunctional methacrylate is particularly preferable.

It has been confirmed that a polyfunctional methacrylate has higher resistance to an acidic gas or the like than a polyfunctional acrylate. Therefore, when a polyfunctional acrylate is used as a curable resin for the protective layer, the polyfunctional acrylate is easily deteriorated by an acidic gas or the like generated from a charger or the like to easily cause image deletion while printing is repeated, whereas when a polyfunctional methacrylate is used, occurrence of image deletion can be suppressed even when printing is repeated.

Examples of the polyfunctional acrylate include urethane acrylate, alkyl acrylate, hydroxyl group-containing alkyl acrylate, polyethylene glycol acrylate, polypropylene glycol acrylate, polytetramethylene glycol acrylate, dioxane acrylate, tricyclodecanol acrylate, fluorene acrylate, alkoxylated bisphenol A acrylate, (alkoxylated)trimethylolpropane acrylate, (alkoxylated) ditrimethylolpropane acrylate, (alkoxylated)glycerin acrylate, (caprolactone-modified) isocyanurate acrylate, (alkoxylated) pentaerythritol acrylate, (alkoxylated)ditrimethylolpropane methacrylate, (alkoxylated)dipentaerythritol methacrylate, polypentaerythritol polyacrylate, and dendritic polymer acrylate. Among these, urethane acrylate, (alkoxylated)trimethylolpropane acrylate, (alkoxylated)ditrimethylolpropane acrylate, (alkoxylated) pentaerythritol acrylate, and (alkoxylated)dipentaerythritol acrylate are preferable, and urethane acrylate, (alkoxylated)ditrimethylolpropane acrylate, and (alkoxylated) pentaerythritol acrylate are more preferable.

Examples of the polyfunctional methacrylate include urethane methacrylate, alkyl methacrylate, hydroxyl group-containing methacrylate, polyethylene glycol methacrylate, polypropylene glycol methacrylate, tricyclodecanol methacrylate, ethoxylated bisphenol A methacrylate, (alkoxylated)trimethylolpropane methacrylate, (alkoxylated)ditrimethylolpropane methacrylate, ethoxylated glycerin methacrylate, (alkoxylated) pentaerythritol methacrylate, (alkoxylated)ditrimethylolpropane methacrylate, and (alkoxylated)dipentaerythritol methacrylate. Among these, urethane methacrylate, (alkoxylated)trimethylolpropane methacrylate, (alkoxylated)ditrimethylolpropane methacrylate, (alkoxylated) pentaerythritol methacrylate, and (alkoxylated)dipentaerythritol methacrylate are preferable, and urethane methacrylate, (alkoxylated)trimethylolpropane methacrylate, and (alkoxylated)ditrimethylolpropane methacrylate are more preferable.

The number of functional groups of the polyfunctional methacrylate is preferably two or more from the viewpoint of hardness, and more preferably three or more from the viewpoint of elastic deformation rate. Meanwhile, the number of functional groups is preferably 10 or less, more preferably 6 or less from the viewpoint of the degree of curing, and more preferably 4 or less from the viewpoint of the degree of curing.

In a case where the present protective layer contains metal oxide particles, the content of the metal oxide particles is preferably 20 parts by mass or more, and more preferably 60 parts by mass or more, per 100 parts by mass of the curable compound, from the viewpoint of electrical characteristics. Meanwhile, the content is preferably 500 parts by mass or less, and more preferably 200 parts by mass or less.

### Solvent Used in Coating Liquid for Forming Protective Layer

Examples of the organic solvent used in the coating liquid for forming the present protective layer include alcohols, such as methanol, ethanol, propanol, and 2-methoxyethanol; ethers, such as tetrahydrofuran, 1,4-dioxane, and dimethoxyethane; esters, such as methyl formate and ethyl acetate; ketones such as acetone, methyl ethyl ketone, and cyclohexanone; aromatic hydrocarbons, such as benzene, toluene, xylene, and anisole; chlorinated hydrocarbons, such as dichloromethane, chloroform, 1,2-dichloroethane, 1,1,2-trichloroethane, 1,1,1-trichloroethane, tetrachloroethane, 1,2-dichloropropane, and trichloroethylene; nitrogen-containing compounds, such as n-butylamine, isopropanolamine, diethylamine, triethanolamine, ethylenediamine, and triethylenediamine; and aprotic polar solvents, such as acetonitrile, N-methylpyrrolidone, N,N-dimethylformamide, and dimethyl sulfoxide. A mixed solvent of these solvents in any combination and in any proportions can also be used. Even an organic solvent that does not dissolve the material for the protective layer of the present electrophotographic photoreceptor by itself can be used as long as the material can be dissolved in a mixed solvent obtained by mixing this organic solvent with, for example, the above-described organic solvent. In general, the use of a mixed solvent can reduce coating unevenness. When a dip coating method is used in the coating method described below, it is preferable to select a solvent that does not dissolve a lower layer. From this viewpoint, an alcohol having low solubility in polycarbonate or polyarylate suitably used in the photosensitive layer is preferably contained.

The amount ratio of the organic solvent to the solid component used in the coating liquid for forming the present protective layer varies depending on the method for applying the coating liquid for forming the present protective layer, and may be appropriately changed so that a uniform coating film is formed in the coating method to be used.

### Content in Coating Liquid for Forming Present Protective Layer

The blending proportion of the compound having a structure represented by Formula (3) or Formula (4) relative to the curable compound is preferably 0.1 parts by mass or more and 15 parts by mass or less per 100 parts by mass of the curable compound.

The blending proportion of the compound having a structure represented by Formula (3) or Formula (4) is preferably 0.1 parts by mass or more per 100 parts by mass of the curable compound, from the viewpoint of promoting curing of the protective layer. From such a viewpoint, the blending proportion of the compound represented by Formula (3) or Formula (4) is more preferably 0.3 parts by mass or more, more preferably 1 part by mass or more, and still more preferably 3 parts by mass or more.

Meanwhile, the blending proportion of the compound having a structure represented by Formula (3) or Formula (4) is preferably 15 parts by mass or less per 100 parts by mass of the curable compound from the viewpoint of electrical measurement. From such a viewpoint, the blending proportion of the compound represented by Formula (3) or Formula (4) is more preferably 10 parts by mass or less, more preferably 8 parts by mass or less, and still more preferably 6 parts by mass or less.

In a case where metal oxide particles are blended in the coating liquid for forming the present protective layer, the blending proportion of the compound having a structure represented by Formula (3) or Formula (4) is preferably 0.3 parts by mass or more and 15 parts by mass or less per 100 parts by mass of the metal oxide particles.

The blending proportion of the compound having a structure represented by Formula (3) or Formula (4) is preferably 0.3 parts by mass or more per 100 parts by mass of the metal oxide particles from the viewpoint of promoting curing of the protective layer. From such a viewpoint, the blending proportion of the compound represented by Formula (3) or Formula (4) is more preferably 1 part by mass or more, more preferably 2 parts by mass or more, and still more preferably 3 parts by mass or more.

Meanwhile, the blending proportion of the compound having a structure represented by Formula (3) or Formula (4) is preferably 15 parts by mass or less per 100 parts by mass of the metal oxide particles from the viewpoint of suppressing aggregation of the metal oxide particles. From such a viewpoint, the blending proportion of the compound represented by Formula (3) or Formula (4) is more preferably 10 parts by mass or less, more preferably 8 parts by mass or less, and still more preferably 6 parts by mass or less.

### Coating Method

The method for applying the coating liquid for forming the present protective layer is not particularly limited, and examples thereof include a spray coating method, a spiral coating method, a ring coating method, and a dip coating method.

After a coating film is formed by the above coating method, the coating film is dried. In this case, the temperature and time of drying are not limited as long as necessary and sufficient drying is achieved. However, when the protective layer is applied only by air drying after application of the photosensitive layer, it is preferable to perform sufficient drying by the method described in a method for forming a photosensitive layer described below.

### Method for Curing Present Protective Layer

The present protective layer can be formed by applying the coating liquid for forming the present protective layer and then curing the coating liquid by applying energy from the outside. Examples of external energy used at this time include heat, light, and radiation.

Examples of a method for applying heat energy include heating methods using gases such as air and nitrogen, steam, various heating media, infrared rays, and electromagnetic waves. The heating may be performed from the coated surface side or the support side. The heating temperature is preferably 100° C. or higher and 170° C. or lower.

For application of light energy, a UV irradiation light source such as a high-pressure mercury lamp having an emission wavelength mainly in the ultraviolet (UV) region, a metal halide lamp, an electrodeless lamp bulb, or a light-emitting diode can be used. A visible light source can be selected according to the absorption wavelength of the chain-polymerizable compound or the photopolymerization initiator.

The light irradiation amount is preferably 10 J/cm² or more, more preferably 30 J/cm² or more, and particularly preferably 100 J/cm² or more, from the viewpoint of curability. From the viewpoint of electrical characteristics, the light irradiation amount is preferably 500 J/cm² or less, more preferably 300 J/cm² or less, and particularly preferably 200 J/cm² or less.

Meanwhile, examples of the energy of radiation include energy obtained using an electron beam (EB).

Among these energies, the energy of light is preferably used from the viewpoint of ease of reaction rate control, simplicity of the apparatus, and the length of pot life.

After curing of the protective layer, a heating step may be added from the viewpoint of relaxation of residual stress, relaxation of residual radicals, and improvement of electrical characteristics. The heating temperature is preferably 60° C. or higher, and more preferably 100° C. or higher, and is preferably 200° C. or lower, and more preferably 150° C. or lower.

### Layer Thickness

The thickness of the present protective layer is preferably 0.5 μm or more, and more preferably 1 μm or more, from the viewpoint of abrasion resistance. Meanwhile, from the viewpoint of electrical characteristics, the thickness is preferably 5 μm or less, and more preferably 3 μm or less.

From the same viewpoint, the thickness of the present protective layer is preferably 1/50 or more, more preferably 1/40 or more, and still more preferably 1/30 or more, with respect to the thickness of the present photosensitive layer. Meanwhile, the thickness is preferably ⅓ or less, more preferably ⅕ or less, and still more preferably 1/10 or less.

### Present Photosensitive Layer

The photosensitive layer in the present electrophotographic photoreceptor (hereinafter also referred to as “the present photosensitive layer”) only needs to be a layer containing at least a charge generation material (CGM) and a charge transport material.

The present photosensitive layer may be a single-layer type photosensitive layer containing both a charge generation material and a charge transport material in the same layer, or may be a laminated type photosensitive layer separated into a charge generation layer and a charge transport layer.

### Single-Layer Type Photosensitive Layer

In a case where the present photosensitive layer is a single-layer type photosensitive layer, at least a charge generation material (CGM), a hole transport material (HTM), an electron transport material (ETM), and a binder resin are preferably contained in the same layer.

### Charge Generation Material (CGM)

As the charge generation material used in the present photosensitive layer, various photoconductive materials such as inorganic photoconductive materials and organic pigments can be used. Among these, organic pigments are particularly preferable, and phthalocyanine pigments and azo pigments are more preferable.

In particular, when a phthalocyanine pigment is used as the charge generation material, specifically, metal-free phthalocyanine, phthalocyanine in which a metal such as copper, indium, gallium, tin, titanium, zinc, vanadium, silicon, or germanium, or an oxide or halide thereof is coordinated, or the like is used. Examples of the ligand to a trivalent or higher valent metal atom include a hydroxy group and an alkoxy group besides the oxygen atom and the chlorine atom described above. Among these, X-type and t-type metal-free phthalocyanine, A-type, B-type, and D-type titanyl phthalocyanine, vanadyl phthalocyanine, chloroindium phthalocyanine, chlorogallium phthalocyanine, hydroxygallium phthalocyanine, and the like, which have particularly high sensitivity, are suitable.

In the case of using an azo pigment, various known bisazo pigments and trisazo pigments are suitably used.

One type of charge generation material may be used alone, or two or more types thereof may be used in any combination and in any proportions. Further, in the case of using two or more types of charge generation materials in combination, as a method of mixing the charge generation materials to be used in combination, the respective charge generation materials may be mixed later, or may be mixed in production and treatment steps of the charge generation materials, such as synthesis, pigmentation, and crystallization.

From the viewpoint of electrical characteristics, the particle size of the charge generation material is desirably small. Specifically, the particle size of the charge generation material is preferably 1 μm or less, and more preferably 0.5 μm or less. The lower limit of the particle size is 0.01 μm or more. The particle size of the charge generation material means the particle size of the charge generation material contained in the photosensitive layer.

Further, the amount of the charge generation material in the single-layer type photosensitive layer is preferably 0.1 mass % or more, and more preferably 0.5 mass % or more, from the viewpoint of sensitivity. The amount is preferably 50 mass % or less, and more preferably 20 mass % or less, from the viewpoint of sensitivity and chargeability.

### Charge Transport Material

The charge transport material is classified into a hole transport material mainly having a hole transport ability and an electron transport material mainly having an electron transport ability. However, in a case where the present photosensitive layer is a single-layer type photosensitive layer, at least a hole transport material and an electron transport material are preferably contained in the same layer.

### Hole Transport Material (HTM)

The hole transport material (HTM) can be selected from known materials and used. Examples of the hole transport material include heterocyclic compounds, such as carbazole derivatives, indole derivatives, imidazole derivatives, oxazole derivatives, pyrazole derivatives, thiadiazole derivatives, and benzofuran derivatives; aniline derivatives; hydrazone derivatives; arylamine derivatives; stilbene derivatives; butadiene derivatives; enamine derivatives; and electron donating materials, such as compounds in which a plurality of these compounds are bonded, and polymers having a group made of these compounds in a main chain or a side chain.

Among these, carbazole derivatives, arylamine derivatives, stilbene derivatives, butadiene derivatives, enamine derivatives, and compounds in which a plurality of these compounds are bonded are preferable, and arylamine derivatives and enamine derivatives are more preferable.

The molecular weight of the hole transport material is preferably 600 or more, more preferably 650 or more, still more preferably 700 or more, and particularly preferably 740 or more, from the viewpoint of electrical characteristics. Meanwhile, from the viewpoint of ease of synthesis and stability of the compound, the molecular weight is preferably 1200 or less, more preferably 1000 or less, and still more preferably 900 or less.

Only one type of hole transport material may be used alone, or two or more types thereof may be used in any combination and in any proportions.

Structures of preferred hole transport materials are exemplified below.

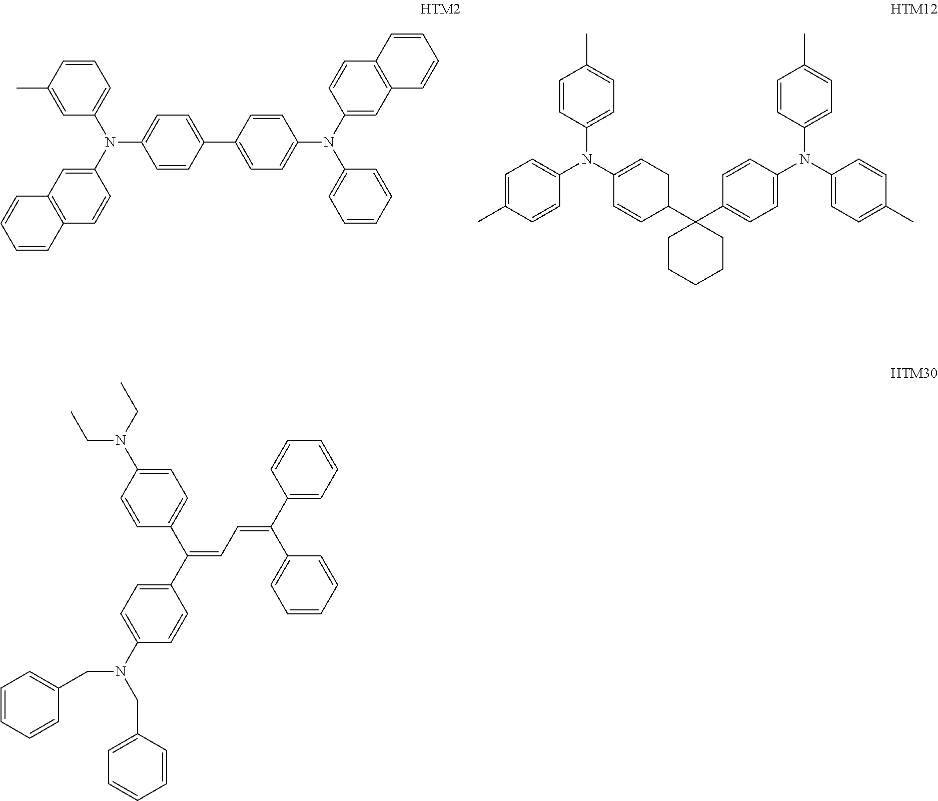

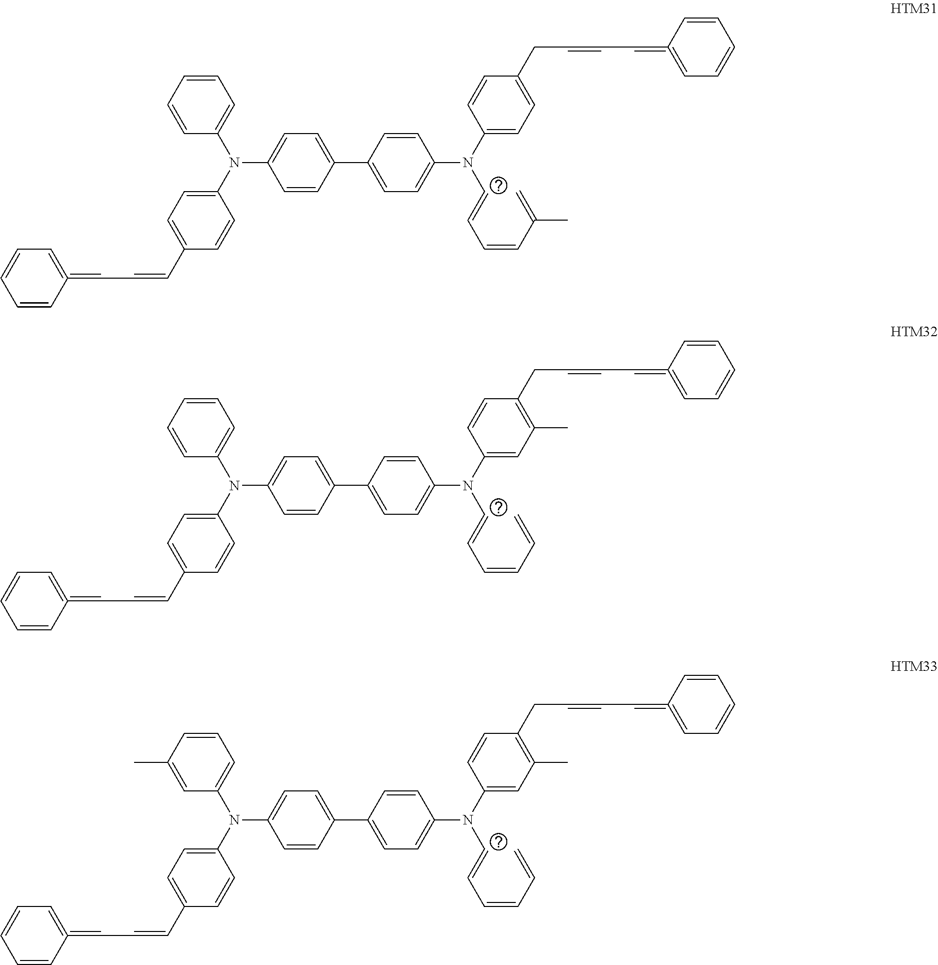

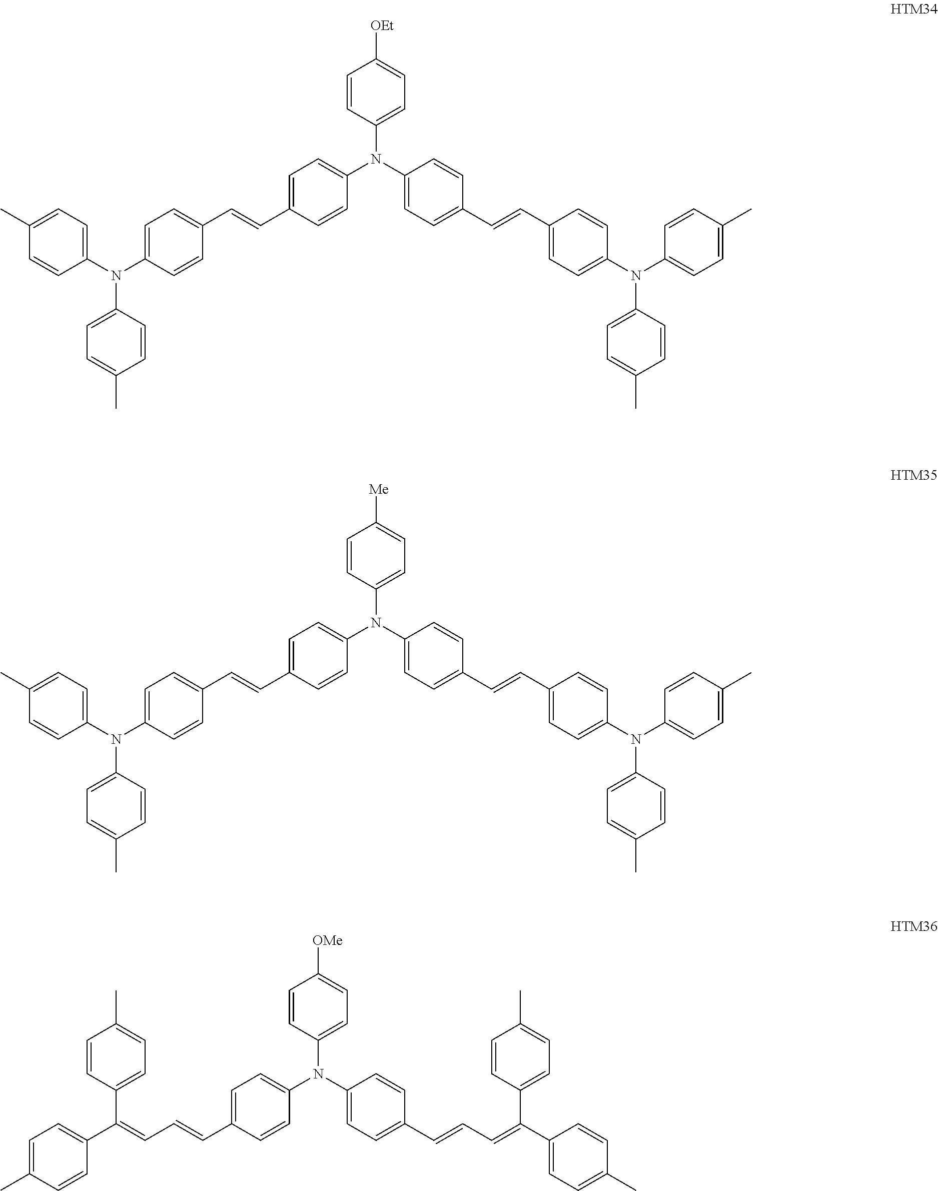

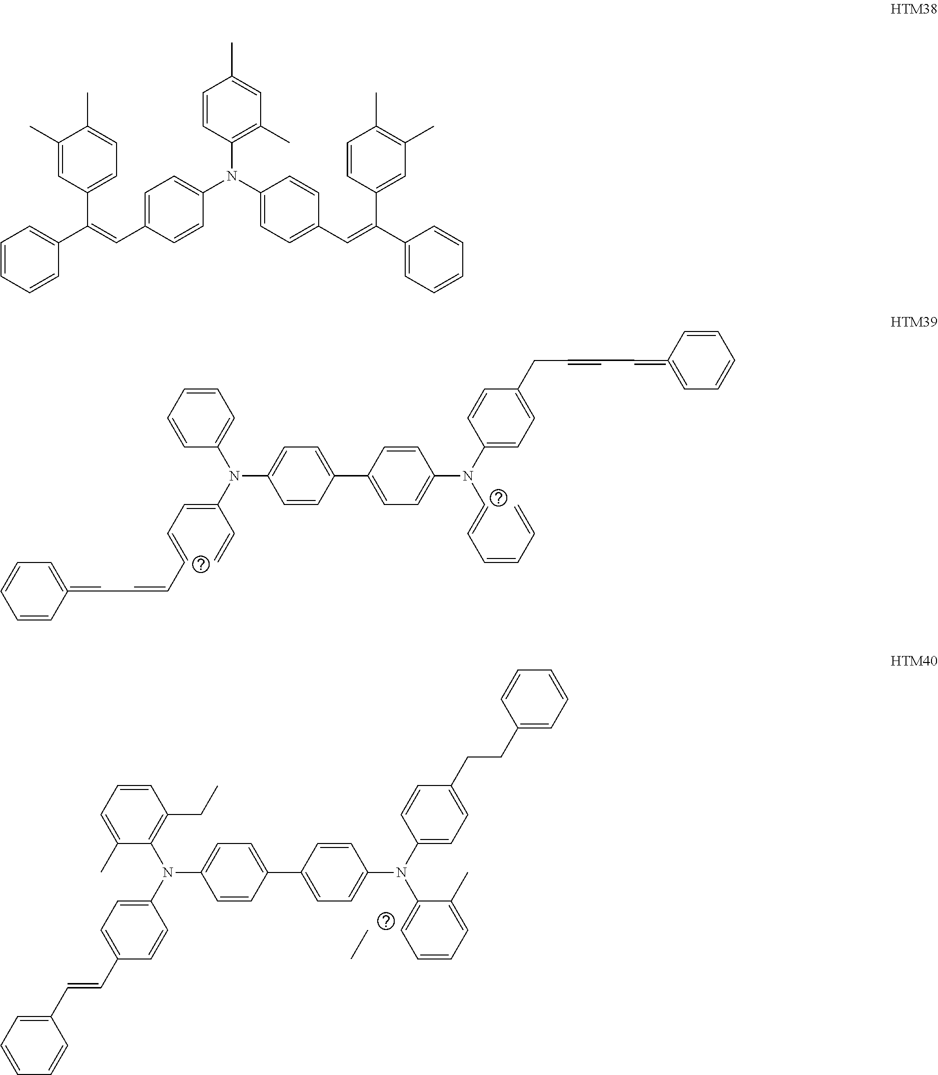

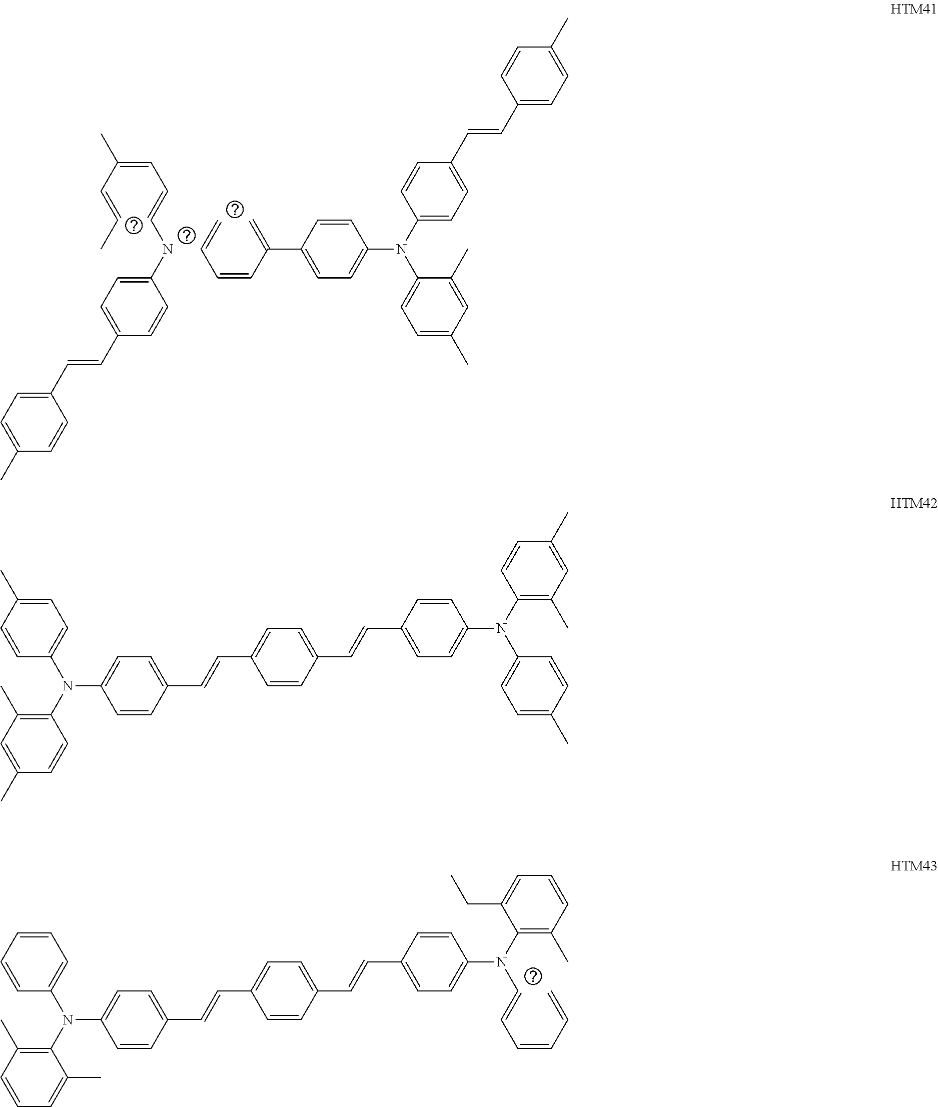

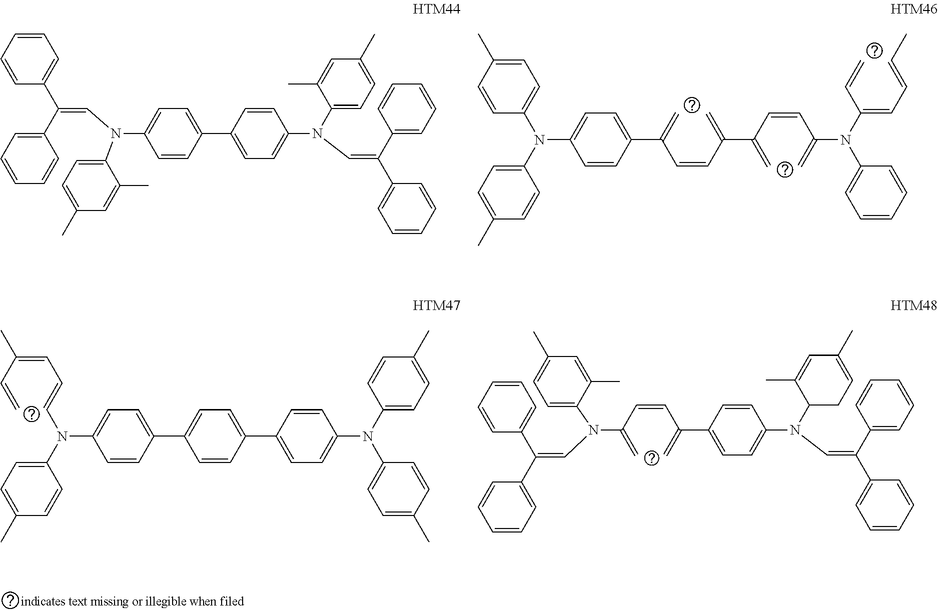 [SMILES: Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1 ; C=C/C(=C\C=C\C)N(C(=C)/C=C\C(=C)C(=C)/C=C\C(=C)c1ccc(N(c2ccc(C)cc2)c2ccc(C)cc2)cc1)c1ccccc1 ; C=C/C(C)=C\C=C\N(c1ccc(C)cc1)c1ccc(-c2ccc(-c3ccc(N(c4ccc(C)cc4)c4ccc(C)cc4)cc3)cc2)cc1 ; C=C(/C=C\C(=C)N(C=C(c1ccccc1)c1ccccc1)c1ccc(C)cc1C)c1ccc(N(C=C(c2ccccc2)c2ccccc2)C2CC=C(C)C=C2C)cc1]

Among the above-described hole transport materials, from the viewpoint of electrical characteristics, HTM31, HTM32, HTM33, HTM34, HTM35, HTM39, HTM40, HTM41, HTM42, HTM43, and HTM48 are preferable, and HTM39, HTM40, HTM41, HTM42, HTM43, and HTM48 are more preferable.

### Electron Transport Material (ETM)

The electron transport material (ETM) can be selected from known materials and used. Examples of the electron transport material include electron attracting materials, including aromatic nitro compounds, such as 2,4,7-trinitrofluorenone, cyano compounds such as tetracyanoquinodimethane, and quinone compounds, such as diphenoquinone, known cyclic ketone compounds, and perylene pigments (perylene derivatives). Among these, from the viewpoint of electrical characteristics, a quinone compound and a perylene pigment (perylene derivative) are preferable, and a quinone compound is more preferable.

Among the quinone compounds, diphenoquinone or dinaphthylquinone is preferable from the viewpoint of electrical characteristics. Among these, dinaphthylquinone is more preferable.

The molecular weight of the electron transport material is preferably 400 or more, more preferably 410 or more, and still more preferably 420 or more, from the viewpoint of electrical characteristics. Meanwhile, the molecular weight is preferably 1000 or less, more preferably 800 or less, and still more preferably 600 or less.

Only one type of electron transport material may be used alone, or two or more types thereof may be used in any combination and in any proportions.

Structures of preferred electron transport materials are exemplified below.

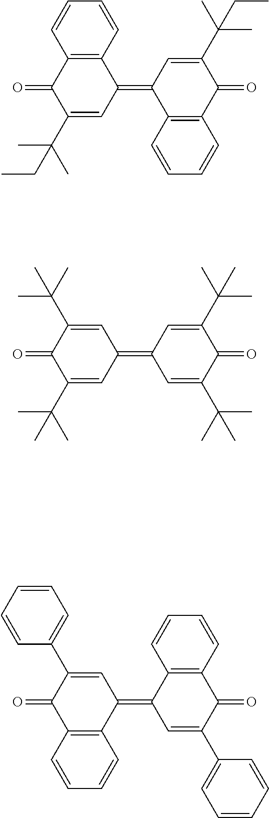 [SMILES: CCC(C)(C)C1=C/C(=C2/C=C(C(C)(C)CC)C(=O)c3ccccc32)c2ccccc2C1=O ; CC(C)(C)C1=CC(=C2C=C(C(C)(C)C)C(=O)C(C(C)(C)C)=C2)C=C(C(C)(C)C)C1=O ; O=C1C(c2ccccc2)=C/C(=C2/C=C(c3ccccc3)C(=O)c3ccccc32)c2ccccc21]

Among the electron transport materials described above, ET-2 and ET-5 are preferable, and ET-2 is more preferable, from the viewpoint of electrical characteristics.

### Content of Hole Transport Material and Electron Transport Material

The ratio of the content mass of the electron transport material to the content mass of the hole transport material in the single-layer type photosensitive layer is preferably 0.3 or more from the viewpoint of an electron transport property, and more preferably 0.4 or more from the viewpoint of electrical characteristics. Meanwhile, the ratio is preferably 1.0 or less from the viewpoint of a hole transport property, more preferably 0.9 or less from the viewpoint of suppressing precipitation of the electron transport material, and still more preferably 0.8 or less from the viewpoint of adhesiveness.

From the viewpoint of a hole transport property, the content of the hole transport material in the present electrophotographic photoreceptor is preferably 50 parts by mass or more, more preferably 80 parts by mass or more, and still more preferably 90 parts by mass or more, per 100 parts by mass of a binder resin described below. Meanwhile, the upper-limit value of the content is more preferably 200 parts by mass or less, and still more preferably 150 parts by mass or less, from the viewpoint of suppressing precipitation.

### Binder Resin

Next, the binder resin used in the present photosensitive layer will be described.

Examples of the binder resin used in the present photosensitive layer include vinyl polymers, such as polymethyl methacrylate, polystyrene, and polyvinyl chloride or copolymers thereof; vinyl alcohol resins; polyvinyl butyral resins; polyvinyl formal resins; partially modified polyvinyl acetal resins; polyarylate resins; polyamide resins; polyurethane resins; polycarbonate resins; polyester resins; polyester carbonate resins; polyimide resins; phenoxy resins; epoxy resins; silicone resins; and partially crosslinked cured products thereof. The resin may be modified with a silicon reagent or the like. One type of these resins may be used alone, or two or more types thereof may be used in any proportions and in any combination.

The binder resin used in the present photosensitive layer preferably contains one type or two or more types of polymers obtained by interfacial polymerization.

As the binder resin obtained by the interfacial polymerization, a polycarbonate resin and a polyester resin are preferable, and a polycarbonate resin or a polyarylate resin is particularly preferable. In particular, a polymer made from an aromatic diol as a raw material is preferable.

### Additional Material

In addition to the above materials, the present photosensitive layer may contain an additive such as a well-known antioxidant, plasticizer, ultraviolet absorber, electron-attracting compound, leveling agent, or visible light shielding agent for improving film formability, flexibility, applicability, stain resistance, gas resistance, light resistance, or the like. The present photosensitive layer may contain any additive such as a sensitizer, a dye, a pigment (excluding the charge generation material, the hole transport material, and the electron transport material described above), or a surfactant, as necessary. Examples of the surfactant include silicone oil and fluorine-based compounds. In the present disclosure, as appropriate, one type of these may be used alone, or two or more types thereof may be used in any proportions and in any combination.

For the purpose of reducing frictional resistance of the surface of the photosensitive layer, the photosensitive layer may contain a fluorine-based resin, a silicone resin, or the like, or may contain particles made of such a resin or particles of an inorganic compound such as aluminum oxide.

### Layer Thickness

In a case where the present photosensitive layer is a single-layer type photosensitive layer, the thickness of the present photosensitive layer is preferably 20 μm or more, and more preferably 25 μm or more, from the viewpoint of dielectric breakdown resistance. Meanwhile, from the viewpoint of electrical characteristics, the thickness is preferably 50 μm or less, and more preferably 40 μm or less.

### Laminated Type Photosensitive Layer

When the present electrophotographic photoreceptor is a laminated type photosensitive layer, the photosensitive layer can have, for example, a structure in which a charge transport layer (CTL) containing an electron transport material (ETM) and a hole transport material (HTM) is laminated on a charge generation layer (CGL) containing a charge generation material (CGM). In this case, an additional layer other than the charge generation layer (CGL) and the charge transport layer (CTL) can also be provided.

### Charge Generation Layer (CGL)

The charge generation layer usually contains a charge generation material (CGM) and a binder resin.

The charge generation material (CGM) and the binder resin are the same as those described above for the single-layer type photosensitive layer.

### Additional Component

The charge generation layer may contain an additional component as necessary in addition to the charge generation material and the binder resin. The charge generation layer may contain an additive, such as a known antioxidant, plasticizer, ultraviolet absorber, electron-attracting compound, leveling agent, visible light shielding agent, or filler, for the purpose of improving, for example, film formability, flexibility, applicability, stain resistance, gas resistance, or light resistance.

### Blending Ratio

In the charge generation layer, when the proportion of the charge generation material is too high, the stability of the coating liquid may be lowered due to aggregation of the charge generation material, whereas when the proportion of the charge generation material is too low, the sensitivity as a photoreceptor may be lowered. Therefore, for the blending ratio (mass) of the charge generation material to the binder resin, the charge generation material is preferably contained in a proportion of 10 parts by mass or more, and more preferably contained in a proportion of 30 parts by mass or more, and is preferably contained in a proportion of 1000 parts by mass or less, and more preferably contained in a proportion of 500 parts by mass or less, per 100 parts by mass of the binder resin. From the viewpoint of film strength, the charge generation material is more preferably contained in a proportion of 300 parts by mass or less, and still more preferably contained in a proportion of 200 parts by mass or less.

### Layer Thickness

The thickness of the charge generation layer is preferably 0.1 μm or more, and more preferably 0.15 μm or more. Meanwhile, the thickness is preferably 10 μm or less, and more preferably 0.6 μm or less.

### Charge Transport Layer (CTL)

The charge transport layer (CTL) usually contains a hole transport material (HTM) and a binder resin, and may further contain an electron transport material (ETM).

The electron transport material (ETM), the hole transport material (HTM), and the binder resin are the same as those described for the single-layer type photosensitive layer.

In the charge transport layer (CTL), regarding the blending proportion of the hole transport material (HTM) relative to the binder resin, the hole transport material (HTM) is preferably blended in a proportion of 20 parts by mass or more, more preferably blended in a proportion of 30 parts by mass or more from the viewpoint of reducing the residual potential, and still more preferably blended in a proportion of 40 parts by mass or more from the viewpoint of stability and charge mobility in repeated use, per 100 parts by mass of the binder resin. Meanwhile, from the viewpoint of thermal stability of the photosensitive layer, the hole transport material (HTM) is preferably blended in a proportion of 200 parts by mass or less, more preferably blended in a proportion of 150 parts by mass or less from the viewpoint of compatibility between the hole transport material (HTM) and the binder resin, and particularly preferably blended in a proportion of 120 parts by mass or less from the viewpoint of glass transition temperature, per 100 parts by mass of the binder resin.

### Additional Component

The charge transport layer may contain an additional component as necessary in addition to the electron transport material (ETM), the hole transport material (HTM), and the binder resin. The charge transport layer may contain an additive such as a known antioxidant, plasticizer, ultraviolet absorber, electron-attracting compound, leveling agent, visible light shielding agent, or filler, for the purpose of improving, for example, film formability, flexibility, applicability, stain resistance, gas resistance, or light resistance.

### Layer Thickness

The thickness of the charge transport layer is not particularly limited. From the viewpoint of electrical characteristics, image stability, and further high resolution, the thickness is preferably 5 μm or more and 50 μm or less, more preferably 10 μm or more or 35 μm or less, and still more preferably 15 μm or more or 25 μm or less.

### Method for Forming Photosensitive Layer

In each of the laminated type and the single-layer type, the respective layers described above can be formed as follows.

The layers can be formed by repeating, for each layer sequentially, steps of applying a coating liquid obtained by dissolving or dispersing a material to be contained in a solvent onto the electroconductive support by a known method such as dip coating, spray coating, nozzle coating, bar coating, roll coating, or blade coating, and drying the coating liquid.

However, the method is not limited to such a forming method.

The solvent or dispersion medium used for preparing the coating liquid is not particularly limited. Specific examples of the solvent or dispersion medium include alcohols, such as methanol, ethanol, propanol, and 2-methoxyethanol; ethers, such as tetrahydrofuran, 1,4-dioxane, and dimethoxyethane; aromatic hydrocarbons, such as benzene, toluene, and xylene; and chlorinated hydrocarbons, such as dichloromethane, chloroform, 1,2-dichloroethane, 1,1,2-trichloroethane, 1,1,1-trichloroethane, tetrachloroethane, 1,2-dichloropropane, and trichloroethylene. One type of these may be used alone, or two or more types thereof may be used in any combination and species.

The amount of the solvent or the dispersion medium to be used is not particularly limited. It is preferable to appropriately adjust the solid component concentration and physical properties such as viscosity of the coating liquid to be in desired ranges in consideration of the purpose of each layer and the properties of the selected solvent or dispersion medium.

The coating film is preferably dried by heating at rest or under air blowing usually in a temperature range of 30° C. or higher and 200° C. or lower for from 1 minute to 2 hours after drying to touch at room temperature. The heating temperature may be constant, or the heating may be performed while changing the temperature during drying.

### Present Electroconductive Support

The electroconductive support of the present electrophotographic photoreceptor (also referred to as “the present electroconductive support”) is not particularly limited as long as it supports a layer formed thereon and exhibits electroconductivity.

As the present electroconductive support, for example, a metal material, such as aluminum, an aluminum alloy, stainless steel, copper, or nickel; a resin material to which electroconductivity is imparted by coexistence of an electroconductive powder of metal, carbon, or tin oxide; or a resin, glass, paper, or the like having an electroconductive material such as aluminum, nickel, or ITO (indium tin oxide alloy) deposited or applied on the surface thereof can be mainly used.

The present electroconductive support may be in the form of a drum, cylinder, sheet, belt, or the like.

The present electroconductive support may be an electroconductive support made of a metal material to which an electroconductive material having an appropriate resistance value is applied for controlling electroconductivity, surface properties, and the like or for covering defects.

When a metal material such as an aluminum alloy is used as the present electroconductive support, an anodized film may be applied to the metal material before use.

The average thickness of the anodized film is preferably 20 μm or less, and more preferably 7 μm or less.

In the case of forming an anodized film on the metal material, it is preferable to perform sealing treatment. The sealing treatment can be performed by a known method.

The surface of the present electroconductive support may be smooth or may be roughened by using a special machining method or by performing a polishing treatment. The support may be roughened by mixing particles having an appropriate particle size with the material constituting the support.

An undercoat layer described below may be provided between the present electroconductive support and the photosensitive layer for the purpose of improving adhesiveness, blocking property, and the like.

### Present Undercoat Layer

The present electrophotographic photoreceptor may have an undercoat layer (also referred to as “the present undercoat layer”) between the present photosensitive layer and the present electroconductive support.

As the present undercoat layer, for example, a resin, a resin in which particles of an organic pigment, a metal oxide, or the like are dispersed, or the like can be used.

Examples of the organic pigment used in the undercoat layer include phthalocyanine pigments, azo pigments, and perylene pigments. Among these, phthalocyanine pigments or azo pigments, specifically, phthalocyanine pigments or azo pigments used as the charge generation material described above can be indicated.

Examples of the metal oxide particles used in the present undercoat layer include particles of a metal oxide containing one type of metal element, such as titanium oxide, aluminum oxide, silicon oxide, zirconium oxide, zinc oxide, or iron oxide, and particles of a metal oxide containing a plurality of metal elements, such as calcium titanate, strontium titanate, and barium titanate. In the undercoat layer, only one type of the particles may be used, or a plurality of types of the particles may be mixed and used in any proportions and in any combination.

Among the metal oxide particles described above, titanium oxide and aluminum oxide are preferable, and titanium oxide is particularly preferable. For example, the surfaces of the titanium oxide particles may be treated with any inorganic or organic substance or the like. The crystal form of the titanium oxide particles may be any of rutile, anatase, brookite, and amorphous forms. The titanium oxide particles may include those having a plurality of crystalline states.

The particle size of the metal oxide particles used in the present undercoat layer is not particularly limited. From the viewpoint of properties of the undercoat layer and stability of a solution for forming the undercoat layer, the average primary particle size is preferably 10 nm or more, and is 100 nm or less, and more preferably 50 nm or less.

The binder resin used in the present undercoat layer can be selected from, for example, polyvinyl acetal-based resins, such as polyvinyl butyral resins, polyvinyl formal resins, and partially acetalized polyvinyl butyral resins in which a portion of butyral is modified with formal, acetal, or the like; and insulating resins, such as polyarylate resins, polycarbonate resins, polyester resins, phenoxy resins, acrylic resins, methacrylic resins, polyamide resins, polyurethane resins, epoxy resins, silicone resins, polyvinyl alcohol resins, styrene-alkyd resins, silicone-alkyd resins, and phenol-formaldehyde resins. However, the polymer is not limited to these polymers. These binder resins may be used alone, two or more types thereof may be used in combination, or they may also be used in a form cured with a curing agent.

Among these, polyvinyl acetal-based resins, alcohol-soluble copolymerized polyamides, modified polyamides, and the like are preferable because they exhibit good dispersibility and applicability. Among them, alcohol-soluble copolymerized polyamides are particularly preferable.

The mixing ratio of the particles to the binder resin can be optionally selected. The particles are preferably used in a range of from 10 mass % to 500 mass % from the viewpoint of the stability and applicability of the dispersion.

The thickness of the present undercoat layer may be optionally selected. The thickness is preferably 0.1 μm or more, and more preferably 20 μm or less, in view of the characteristics of the electrophotographic photoreceptor and the applicability of the dispersion. The undercoat layer may contain a known antioxidant or the like.

### Additional Layer

The present electrophotographic photoreceptor may appropriately have an additional layer as necessary, in addition to the present electroconductive support, the present photosensitive layer, the present protective layer, and the present undercoat layer described above.

### Physical Properties of Present Electrophotographic Photoreceptor

The present electrophotographic photoreceptor can have the following physical properties.

### Martens Hardness

In the present electrophotographic photoreceptor, from the viewpoint of providing practically sufficient abrasion resistance, the Martens hardness is preferably 170 N/mm² or more, more preferably 200 N/mm² or more, still more preferably 250 N/mm² or more, and yet still more preferably 300 N/mm² or more.

In the present disclosure, the Martens hardness of the photoreceptor means a Martens hardness as measured from the surface side of the photoreceptor.

The Martens hardness can be measured by a method described in Examples described below.

### Elastic Deformation Rate

From the viewpoint of providing practically sufficient abrasion resistance, the elastic deformation rate of the present electrophotographic photoreceptor is preferably 25% or more, more preferably 30% or more, still more preferably 35% or more, and particularly preferably 40% or more.

In the present disclosure, the elastic deformation rate of the photoreceptor means an elastic deformation rate as measured from the surface side of the photoreceptor.

The elastic deformation rate can be measured by a method described in Examples described below.

### Present Image Forming Apparatus

An image forming apparatus (“the present image forming apparatus”) can be configured using the present electrophotographic photoreceptor.

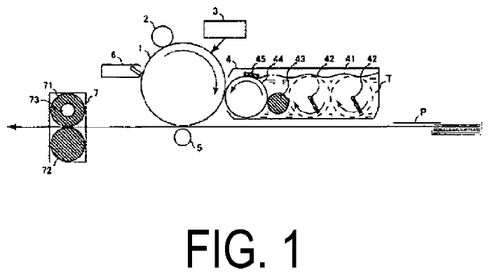

As illustrated in FIG. 1, the present image forming apparatus includes the present electrophotographic photoreceptor 1, a charging device 2, an exposure device 3, and a developing device 4, and further optionally includes a transfer device 5, a cleaning device 6, and a fixing device 7.

The present electrophotographic photoreceptor 1 is not particularly limited as long as it is the above-described present electrophotographic photoreceptor. FIG. 1 illustrates, as an example of the present electrophotographic photoreceptor 1, a drum-shaped photoreceptor in which the above-described photosensitive layer is formed on the surface of a cylindrical electroconductive support. The charging device 2, the exposure device 3, the developing device 4, the transfer device 5, and the cleaning device 6 are disposed along the outer peripheral surface of the present electrophotographic photoreceptor 1.

Examples of the charging device 2 include a non-contact corona charging device, such as a corotron or a scorotron, or a contact charging device (direct charging device) that charges the surface of the photoreceptor by bringing a voltage-applied charging member into contact with the surface of the photoreceptor. Examples of the contact charging device include a charging roller and a charging brush. FIG. 1 illustrates a roller-type charging device (charging roller) as an example of the charging device 2.

The type of the exposure device 3 is not particularly limited as long as the exposure device 3 can expose the present electrophotographic photoreceptor 1 to light to form an electrostatic latent image on a photosensitive surface of the present electrophotographic photoreceptor 1.

Alternatively, the exposure may be performed by a photoreceptor internal exposure method. Any type of light is used for the exposure.

A toner T may be of any type, and may be a powdery toner, or a polymerized toner obtained by suspension polymerization, emulsion polymerization, or the like.

The developing device 4 also has any configuration. The developing device 4 illustrated in FIG. 1 has a configuration in which the toner T is formed into a thin layer by a regulating member (developing blade) 45, is frictionally charged to a predetermined polarity, is conveyed while being carried on a developing roller 44, and is brought into contact with the surface of the photoreceptor 1. However, the developing device 4 is not limited to this configuration.

The type of the transfer device 5 is not particularly limited, and a device using any method such as an electrostatic transfer method such as corona transfer, roller transfer, or belt transfer, a pressure transfer method, or an adhesive transfer method can be used.

The cleaning device 6 is not particularly limited. For example, any cleaning device such as a brush cleaner or a blade cleaner can be used. When the amount of the toner remaining on the surface of the photoreceptor is small or almost zero, the cleaning device 6 may be omitted.

The fixing device 7 also has any configuration.

The image forming apparatus may have, besides the above-described configuration, for example, a configuration that can perform an electrostatic elimination step.

The image forming apparatus may be configured in a further modified manner, and may be configured to be able to perform, for example, a pre-exposure step, an auxiliary charging step, and the like, may be configured to perform offset printing, or may be configured to be a full-color tandem system using a plurality of types of toners.

### Present Electrophotographic Cartridge

The present electrophotographic photoreceptor 1 may be combined with one or two or more of the charging device 2, the exposure device 3, the developing device 4, the transfer device 5, the cleaning device 6, and the fixing device 7 to form an integrated cartridge (referred to as “the present electrophotographic cartridge”).

However, the present electrophotographic cartridge described below is an example of an electrophotographic cartridge that can be configured using the present electrophotographic photoreceptor, and is not limited to the present electrophotographic cartridge.

The present electrophotographic cartridge may have a configuration that is detachably mounted on a main body of an electrophotographic apparatus such as a copying machine or a laser beam printer. In such a case, for example, when the present electrophotographic photoreceptor 1 or another member is deteriorated, the electrophotographic photoreceptor cartridge is detached from the main body of the image forming apparatus, and another new electrophotographic photoreceptor cartridge is attached to the main body of the image forming apparatus, whereby the image forming apparatus is easily maintained and managed.

### Description of Terms

In the present disclosure, the meaning of the expression “X to Y” (X and Y are any numerals) includes “X or more and Y or less” and “preferably more than X” or “preferably less than Y” unless otherwise specified.

When the expression “X or more” (X is any numeral) or “Y or less” (Y is any numeral) is used, the intention thereof includes “preferably more than X” or “preferably less than Y.”

### EXAMPLES

Hereinafter, embodiments of the present disclosure will be described in more detail with reference to Examples. However, the following Examples are described for illustrating the present disclosure in detail, and the present disclosure is not limited to the Examples described below and can be carried out with any modification without departing from the gist of the present disclosure. In the following Examples and Comparative Examples, the term “part(s)” means “part(s) by mass” unless otherwise specified.

### Production of Coating Liquid P1 for Forming Undercoat Layer

20 parts of D-type titanyl phthalocyanine showing a clear peak at a diffraction angle 2θ=27.3°±0.2° in powder X-ray diffraction using CuKα rays and 280 parts of 1,2-dimethoxyethane were mixed, and the mixture was pulverized for 2 hours with a sand grinding mill to perform a pulverization dispersion treatment. To the mixture, 400 parts of a 2.5% solution of polyvinyl butyral (trade name “Denka Butyral” #6000C, available from Denki Kagaku Kogyo Kabushiki Kaisha) in 1,2-dimethoxyethane and 170 parts of 1,2-dimethoxyethane were further added and mixed to produce a coating liquid P1 for forming an undercoat layer.

### Production of Coating Liquid Q1 for Forming Single-Layer Type Photosensitive Layer

2.6 parts of D-type titanyl phthalocyanine showing a clear peak at a diffraction angle 2θ=27.3°±0.2° in powder X-ray diffraction using CuKα rays, 1.3 parts of a perylene pigment 1 having a structure described below, 0.5 parts of a polyvinyl butyral resin, 100 parts of a hole transport material described below (HTM48, molecular weight: 748), 60 parts of an electron transport material described below (ET-2, molecular weight: 424.2), 100 parts of a polycarbonate resin having a biphenyl structure, 0.05 parts of silicone oil (trade name KF-96, available from Shin-Etsu Silicone Co., Ltd.) as a leveling agent, and 793.35 parts of a mixed solvent of tetrahydrofuran (hereinafter appropriately abbreviated as THF) and toluene (hereinafter appropriately abbreviated as TL) (THF: 80 mass %, TL: 20 mass %) were mixed to produce a coating liquid Q1 for forming a single-layer type photosensitive layer having a solid component concentration of 25 mass %.

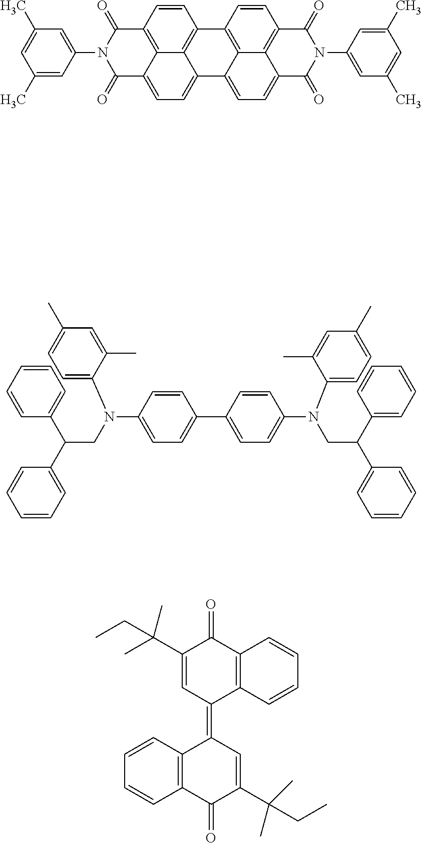

### Production of Coating Liquid S1 for Forming Protective Layer

A curable compound M-1 (product name: TMPT, available from Shin-Nakamura Chemical Co., Ltd.) represented by a structure described below, which had been dissolved in advance in a mixed solvent of methanol/1-propanol/toluene, a compound O-1 represented by a structure described below and serving as a polymerization initiator, and a dispersion slurry of titanium oxide particles (average primary particle size: 40 nm, surface-treated with 3.5 wt. % of methyldimethoxysilane) were mixed to produce a coating liquid S1 for forming a protective layer (solid component concentration: 30 mass %) having a composition of M-1/titanium oxide particles/O-1=100/100/3 (mass proportions) and a solvent composition of methanol/1-propanol/toluene=7/1/2 (mass proportions).

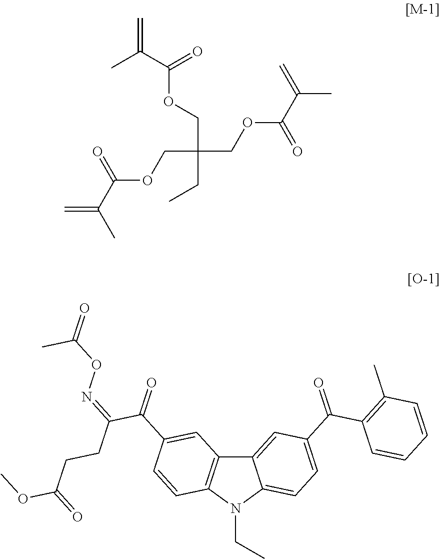

O-1 is a compound represented by Formulae (3) and (4), and R₁ in Formulae (3) and (4) is a structure described below. W represents a bond with carbon to which R₁ is bonded.

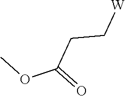

### Production of Coating Liquid S2 for Forming Protective Layer

A coating liquid S2 for forming a protective layer was produced in the same manner as the coating liquid S1 for forming a protective layer, except that the polymerization initiator O-1 was changed to a polymerization initiator O-2 represented by a structure described below.

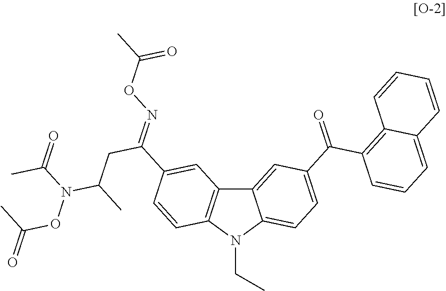 [SMILES: CCn1c2ccc(C(=O)c3cccc4ccccc34)cc2c2cc(/C(CC(C)N(OC(C)=O)C(C)=O)=N/OC(C)=O)ccc21]

O-2 is a compound represented by Formulae (3) and (4), and R₁ in Formulae (3) and (4) is a structure described below. W represents a bond with carbon to which R₁ is bonded.

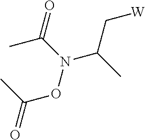

### Production of Coating Liquid S3 for Forming Protective Layer

A coating liquid S3 for forming a protective layer was produced in the same manner as the coating liquid S1 for forming a protective layer, except that the polymerization initiator O-1 was changed to a polymerization initiator 0-3 represented by a structure described below.

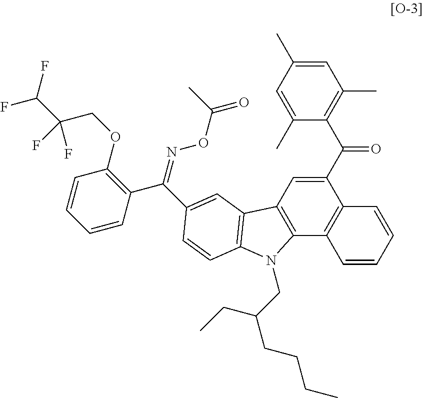 [SMILES: CCCCC(CC)Cn1c2ccc(/C(=N\OC(C)=O)c3ccccc3OCC(F)(F)C(F)F)cc2c2cc(C(=O)c3c(C)cc(C)cc3C)c3ccccc3c21]

O-3 is a compound represented by Formulae (3) and (4), and R₁ in Formulae (3) and (4) is a structure described below. W represents a bond with carbon to which R₁ is bonded.

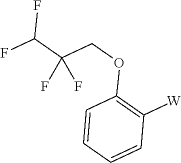

### Production of Coating Liquid S4 for Forming Protective Layer

A coating liquid S4 for forming a protective layer was produced in the same manner as the coating liquid S1 for forming a protective layer, except that the curable compound M-1 was changed to a curable compound M-2 (product name: M-DPH-6E, available from Shin-Nakamura Chemical Co., Ltd.) represented by a structure described below.

### [M−2]

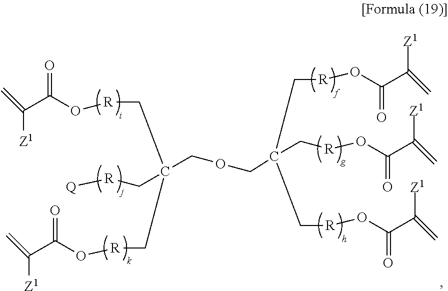

In Formula (19), Rs are each an oxyalkylene group represented by —O—CH₂—CH₂—, f+g+h+i+j+k=6, Q is a hydroxy group or Formula (20) described below, and Z's are each a methyl group.

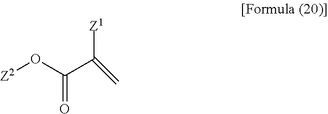

In Formula (20), Z² represents a bond with R in Formula (19). Z¹ represents a methyl group.

### Production of Coating Liquid S5 for Forming Protective Layer

A coating liquid S5 for forming a protective layer was produced in the same manner as the coating liquid S4 for forming a protective layer, except that the polymerization initiator O-1 was changed to the polymerization initiator O-3, and the content was changed to the following proportion. M-DPH-6E/titanium oxide particles/O-3=100/100/6 (mass proportions)

### Production of Coating Liquid S6 for Forming Protective Layer

A coating liquid S6 for forming a protective layer was produced in the same manner as the coating liquid S4 for forming a protective layer, except that the polymerization initiator O-1 was changed to the polymerization initiator O-3, and the content was changed to the following proportion. M-DPH-6E/titanium oxide particles/O-3=100/100/3 (mass proportions)

### Production of Coating Liquid S7 for Forming Protective Layer

A coating liquid S7 for forming a protective layer was produced in the same manner as the coating liquid S4 for forming a protective layer, except that the polymerization initiator O-1 was changed to the polymerization initiator O-3, and the content was changed to the following proportion. M-DPH-6E/titanium oxide particles/O-3=100/100/1 (mass proportions)

### Production of Coating Liquid S8 for Forming Protective Layer

A coating liquid S8 for forming a protective layer was produced in the same manner as the coating liquid S4 for forming a protective layer, except that the polymerization initiator O-1 was changed to the polymerization initiator O-3, and the content was changed to the following proportion. M-DPH-6E/titanium oxide particles/O-3=100/100/0.3 (mass proportions)

### Production of Coating Liquid S9 for Forming Protective Layer

A coating liquid S9 for forming a protective layer was produced in the same manner as the coating liquid S1 for forming a protective layer, except that the polymerization initiator O-1 was changed to a polymerization initiator O-4 (product name: Omnirad 369, available from IGM Resins).

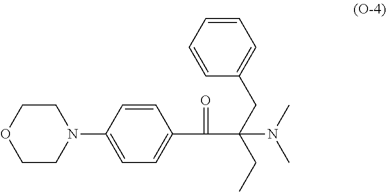 [SMILES: CCC(Cc1ccccc1)(C(=O)c1ccc(N2CCOCC2)cc1)N(C)C]

### Production of Coating Liquid S10 for Forming Protective Layer

A coating liquid S10 for forming a protective layer was produced in the same manner as the coating liquid S1 for forming a protective layer, except that the polymerization initiator O-1 was changed to a polymerization initiator 0-5 (product name: Omnirad 379EG, available from IGM Resins).

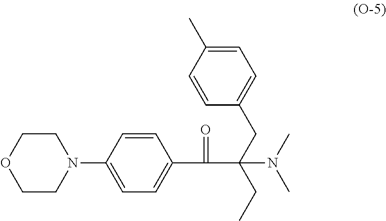 [SMILES: CCC(Cc1ccc(C)cc1)(C(=O)c1ccc(N2CCOCC2)cc1)N(C)C]

### Production of Coating Liquid S11 for Forming Protective Layer

A coating liquid S11 for forming a protective layer was produced in the same manner as the coating liquid S1 for forming a protective layer, except that the polymerization initiator O-1 was changed to polymerization initiators 0-6 (benzophenone, available from Tokyo Chemical Industry Co., Ltd.) and 0-7 (product name: Omnirad TPO H, available from IGM Resins), and the content was changed to the following proportion.

TMPT/titanium oxide particles/O-6/0−7=100/100/1/2 (mass proportions)

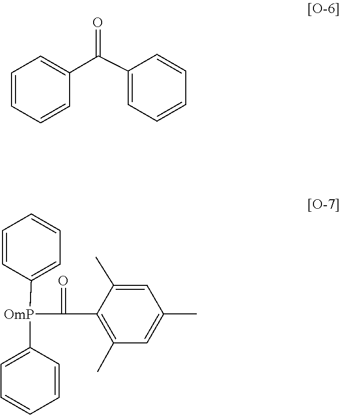

### Production of Coating Liquid S12 for Forming Protective Layer

A coating liquid S12 for forming a protective layer was produced in the same manner as the coating liquid S11 for forming a protective layer, except that the curable compound M-1 was changed to the curable compound M-2 (product name: M-DPH-6E, available from Shin-Nakamura Chemical Co., Ltd.).

### Production of Coating Liquid S13 for Forming Protective Layer

A coating liquid S13 for forming a protective layer was produced in the same manner as the coating liquid S1 for forming a protective layer, except that the polymerization initiator O-1 was changed to a polymerization initiator 0-8 represented by a structure described below.

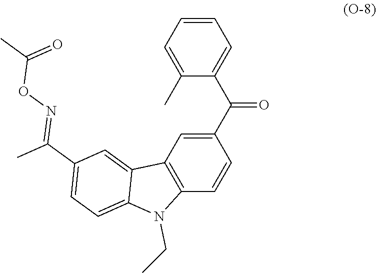 [SMILES: CCn1c2ccc(C(=O)c3ccccc3C)cc2c2cc(/C(C)=N/OC(C)=O)ccc21]

### Production of Coating Liquid S14 for Forming Protective Layer

A coating liquid S14 for forming a protective layer was produced in the same manner as the coating liquid S1 for forming a protective layer, except that the polymerization initiator O-1 was changed to a polymerization initiator 0-9 represented by a structure described below.

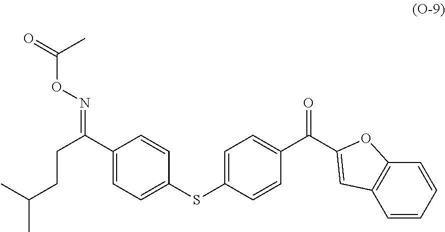 [SMILES: CC(=O)O/N=C(\CCC(C)C)c1ccc(Sc2ccc(C(=O)c3cc4ccccc4o3)cc2)cc1]

### Production of Single-Layer Type Photoreceptor

Single-layer type photoreceptors (photoreceptors A1 to A14) were produced by the following procedure.

### Example 1

The coating liquid P1 for forming an undercoat layer was applied by dip coating to an aluminum cylinder, having a machined surface and a diameter of 30 mm and a length of 244 mm, to form an undercoat layer so that the thickness after drying was 0.3 μm. The coating liquid Q1 for forming a single-layer type photosensitive layer was applied by dip coating onto the undercoat layer and dried at 125° C. for 24 minutes to provide a single-layer type photosensitive layer so that the thickness after drying was 30 μm. The coating liquid S1 for forming a protective layer was applied by ring coating onto the single-layer type photosensitive layer, dried at room temperature for 1 minute, and then irradiated with LED light of 365 nm (132 J/cm²) at an intensity of 1.1 W/cm² for 2 minutes while rotating the photoreceptor at 60 rpm under a nitrogen atmosphere, whereby a protective layer was provided so that the thickness after curing was 2 μm, and a photoreceptor A1 was produced.

### Example 2

A photoreceptor A2 was produced in the same manner as in the photoreceptor A1, except that the coating liquid S1 for forming a protective layer was changed to the coating liquid S2 for forming a protective layer.

### Example 3

A photoreceptor A3 was produced in the same manner as in the photoreceptor A1, except that the coating liquid S1 for forming a protective layer was changed to the coating liquid S3 for forming a protective layer.

### Example 4

A photoreceptor A4 was produced in the same manner as in the photoreceptor A1, except that the coating liquid S1 for forming a protective layer was changed to the coating liquid S4 for forming a protective layer.

### Example 5

A photoreceptor A5 was produced in the same manner as in the photoreceptor A1, except that the coating liquid S1 for forming a protective layer was changed to the coating liquid S5 for forming a protective layer.

### Example 6

A photoreceptor A6 was produced in the same manner as in the photoreceptor A1, except that the coating liquid S1 for forming a protective layer was changed to the coating liquid S6 for forming a protective layer.

### Example 7

A photoreceptor A7 was produced in the same manner as in the photoreceptor A1, except that the coating liquid S1 for forming a protective layer was changed to the coating liquid S7 for forming a protective layer.

### Example 8

A photoreceptor A8 was produced in the same manner as in the photoreceptor A1, except that the coating liquid S1 for forming a protective layer was changed to the coating liquid S8 for forming a protective layer.

### Comparative Example 1

A photoreceptor A9 was produced in the same manner as in the photoreceptor A1, except that the coating liquid S1 for forming a protective layer was changed to the coating liquid S9 for forming a protective layer.

### Comparative Example 2

A photoreceptor A10 was produced in the same manner as in the photoreceptor A1, except that the coating liquid S1 for forming a protective layer was changed to the coating liquid S10 for forming a protective layer.

### Comparative Example 3

A photoreceptor All was produced in the same manner as in the photoreceptor A1, except that the coating liquid S1 for forming a protective layer was changed to the coating liquid S11 for forming a protective layer.

### Comparative Example 4

A photoreceptor A12 was produced in the same manner as in the photoreceptor A1, except that the coating liquid S1 for forming a protective layer was changed to the coating liquid S12 for forming a protective layer.

### Comparative Example 5

A photoreceptor A13 was produced in the same manner as in the photoreceptor A1, except that the coating liquid S1 for forming a protective layer was changed to the coating liquid S13 for forming a protective layer.

### Comparative Example 6

A photoreceptor A14 was produced in the same manner as in the photoreceptor A1, except that the coating liquid S1 for forming a protective layer was changed to the coating liquid S14 for forming a protective layer.

### Measurement of Martens Hardness and Elastic Deformation Rate

The Martens hardness and elastic deformation rate of each of the photoreceptors A1 to A14 produced in the Examples and the Comparative Examples were measured from the surface side of the photoreceptor using a microhardness tester (available from Fischer Instruments K. K.: FISCHERSCOPE HM2000) at a temperature of 25° C. and a relative moisture of 50% under the following measurement conditions. The Martens hardness and elastic deformation rate of each sample are shown in Table 1.

### Conditions for Measuring Martens Hardness and Elastic Deformation Rate

Indenter: Vickers square pyramid diamond indenter with facing angle of 136°
Maximum indentation load: 0.2 mN
Required loading time: 10 seconds
Required unloading time: 10 seconds

The Martens hardness was determined by the following equation. Martens hardness (N/mm²)=maximum indentation load/dent area at maximum indentation load

The elastic deformation rate is a value defined by the following equation and is the ratio of the amount of work performed by a film due to elasticity during unloading to the total amount of work required for indentation. Elastic deformation rate (%)=(We/Wt)×100

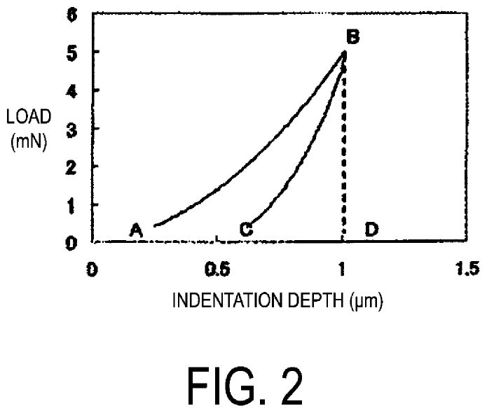

In the equation, the total work amount Wt (nJ) represents an area surrounded by A-B-D-A in FIG. 2, and the elastic deformation work amount We (nJ) represents an area surrounded by C-B-D-C. The larger the elastic deformation rate is, the less deformation due to the load remains, and an elastic deformation rate of 100 means that no deformation remains.

In the present disclosure, a case where the Martens hardness was 170 N/mm² or more was evaluated as “pass.” In addition, a case where the elastic deformation rate was 25% or more was evaluated as “pass.”

### Image Deletion Evaluation

Each of the laminated type photoreceptors A1 to A14 produced in the Examples and Comparative Examples was mounted on an electrophotographic printer, and an image was printed in an environment of a temperature of 32° C. and a relative humidity of 80% and observed at normal temperature and normal humidity.

The degree of image deletion was evaluated as (pass) when no image deletion (image blurring) was observed, and evaluated as x (fail) when image deletion (image blurring) was observed. The results are shown in Table 1.

TABLE 1

| | | | | Content of | | | |
|---|---|---|---|---|---|---|---|
| | | | | polymerization | | | |
| | | Metal | | initiator per | | | |
| | | oxide | Polymerization | 100 parts by | | | |
| | Curable | particles | initiator | mass of metal | | Martens | Elastic |
| | compound | (parts by | (parts by | oxide particles | Image | hardness | deformation |
| | (parts by mass) | mass) | mass) | (mass %) | deletion | (N/mm²) | rate (%) |
| Example 1 | M-1 | Titanium | O-1 | 3 | ◯ | 337 | 29 |
| | (100) | oxide | (3) | | | | |
| | | particles | | | | | |
| | | (100) | | | | | |
| Example 2 | M-1 | Titanium | O-2 | 3 | ◯ | 326 | 31 |
| | (100) | oxide | (3) | | | | |
| | | particles | | | | | |
| | | (100) | | | | | |
| Example 3 | M-1 | Titanium | O-3 | 3 | ◯ | 350 | 36 |
| | (100) | oxide | (3) | | | | |
| | | particles | | | | | |
| | | (100) | | | | | |
| Example 4 | M-2 | Titanium | O-1 | 3 | ◯ | 295 | 39 |
| | (100) | oxide | (3) | | | | |
| | | particles | | | | | |
| | | (100) | | | | | |
| Example 5 | M-2 | Titanium | O-3 | 6 | ◯ | 269 | 42 |
| | (100) | oxide | (6) | | | | |
| | | particles | | | | | |
| | | (100) | | | | | |
| Example 6 | M-2 | Titanium | O-3 | 3 | ◯ | 267 | 40 |
| | (100) | oxide | (3) | | | | |
| | | particles | | | | | |
| | | (100) | | | | | |
| Example 7 | M-2 | Titanium | O-3 | 1 | ◯ | 179 | 35 |
| | (100) | oxide | (1) | | | | |
| | | particles | | | | | |
| | | (100) | | | | | |
| Example 8 | M-2 | Titanium | O-3 | 0.3 | ◯ | 211 | 29 |
| | (100) | oxide | (0.3) | | | | |
| | | particles | | | | | |
| | | (100) | | | | | |
| Comparative | M-1 | Titanium | O-4 | 3 | X | 348 | 39 |
| Example 1 | (100) | oxide | (3) | | | | |
| | | particles | | | | | |
| | | (100) | | | | | |
| Comparative | M-1 | Titanium | O-5 | 3 | X | 357 | 34 |
| Example 2 | (100) | oxide | (3) | | | | |
| | | particles | | | | | |
| | | (100) | | | | | |
| Comparative | M-1 | Titanium | O-6/O-7 | 3 | X | 356 | 42 |
| Example 3 | (100) | oxide | (1/2) | | | | |
| | | particles | | | | | |
| | | (100) | | | | | |
| Comparative | M-2 | Titanium | O-6/O-7 | 3 | X | 348 | 41 |
| Example 4 | (100) | oxide | (1/2) | | | | |
| | | particles | | | | | |
| | | (100) | | | | | |
| Comparative | M-1 | Titanium | O-8 | 3 | X | 336 | 34 |
| Example 5 | (100) | oxide | (3) | | | | |
| | | particles | | | | | |
| | | (100) | | | | | |
| Comparative | M-1 | Titanium | O-9 | 3 | X | 162 | 19 |
| Example 6 | (100) | oxide | (3) | | | | |
| | | particles | | | | | |
| | | (100) | | | | | |

### DISCUSSION

In all Examples 1 to 8, high Martens hardness and high elastic deformation rate were achieved. According to the results obtained in all Examples 1 to 8, image deletion was suppressed.

From the results of the Examples and Comparative Examples described above, and the results of the tests performed by the present inventors, it can be considered that when the protective layer has a structure represented by Formula (1) described below, Martens hardness and elastic deformation rate can be increased, and image deletion can be suppressed.

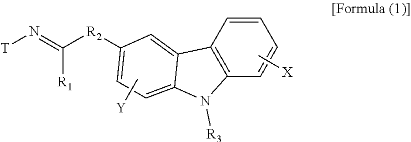

Since the number of carbons of the substituent R₁ in Formula (1) is one in Compound (8) of Comparative Example 5, it is considered that the number of carbons of the substituent R₁ needs to be at least larger than one. Therefore, it is considered that the number of carbons needs to be 2 or more, and is preferably 3 or more.

From the viewpoint of curability, it is considered that R₂ may be a single bond or a carbonyl group.

X, Y, and R₃ do not affect a steric hindrance around the oxime ester site, and thus they may be any substituents. However, from the viewpoint of preventing the influence on particle dispersion, they are preferably nonpolar substituents. From this viewpoint, they may each independently be any of a hydrogen atom, a halogen atom, a nitro group, an acyl group optionally having a substituent, an alkyl group having from 1 to 20 carbons and optionally having a substituent, and an aryl group optionally having a substituent, and it is considered that they may be bonded together and have a cyclic structure.

1. An electrophotographic photoreceptor comprising a photosensitive layer and a protective layer sequentially on an electroconductive support, wherein
the protective layer contains a polymer having a structure represented by Formula (1) described below: 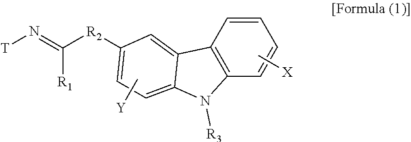
in Formula (1), R₁ represents an organic group having 2 or more carbons; R₂ represents a single bond or a carbonyl group; X, Y, and R₃ each independently represent any substituent; and T represents a bond with any atom.

2. The electrophotographic photoreceptor according to claim 1, wherein the protective layer contains a polymer having a structure represented by Formula (2) described below: 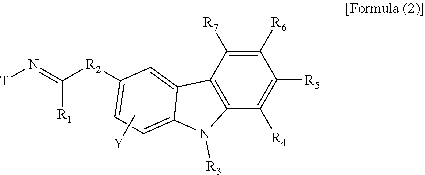
in Formula (2), R₁ represents an organic group having 2 or more carbons; R₂ represents a single bond or a carbonyl group; R₃, R₄, R₅, R₆, and R₇ each independently represent a hydrogen atom, a halogen atom, a nitro group, an acyl group optionally having a substituent, an alkyl group having from 1 to 20 carbons and optionally having a substituent, or an aryl group optionally having a substituent, and may be bonded together and have a cyclic structure; Y represents a hydrogen atom, a halogen atom, a nitro group, an acyl group optionally having a substituent, an alkyl group having from 1 to 20 carbons and optionally having a substituent, or an aryl group optionally having a substituent; and T represents a bond with any atom.

3. An electrophotographic photoreceptor comprising a photosensitive layer and a protective layer sequentially on an electroconductive support, wherein
the protective layer contains a polymer of a compound represented by Formula (3) described below: 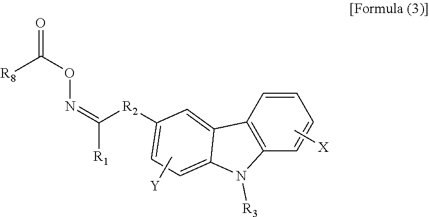
in Formula (3), R₁ represents an organic group having 2 or more carbons; R₂ represents a single bond or a carbonyl group; and X, Y, R₃, and R₈ each independently represent any substituent.

4. The electrophotographic photoreceptor according to claim 3, wherein the protective layer contains a polymer of a compound represented by Formula (4) described below: 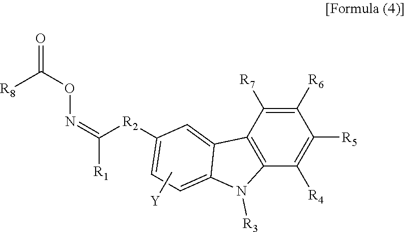
in Formula (4), R₁ represents an organic group having 2 or more carbons; R₂ represents a single bond or a carbonyl group; R₃, R₄, R₅, R₆, and R₇ each independently represent a hydrogen atom, a halogen atom, a nitro group, an acyl group optionally having a substituent, an alkyl group having from 1 to 20 carbons and optionally having a substituent, or an aryl group optionally having a substituent, and may be bonded together and have a cyclic structure; Y represents a hydrogen atom, a halogen atom, a nitro group, an acyl group optionally having a substituent, an alkyl group having from 1 to 20 carbons and optionally having a substituent, or an aryl group optionally having a substituent; and R₈ represents a hydrogen atom, a halogen atom, an alkyl group having from 1 to 20 carbons and optionally having a substituent, or an aryl group optionally having a substituent.

5. The electrophotographic photoreceptor according to claim 2, wherein at least one of R₃, R₄, R₅, R₆, or R₇ is an acyl group optionally having a substituent.

6. The electrophotographic photoreceptor according to claim 5, wherein the acyl group optionally having a substituent is a structure represented by Formula (5): 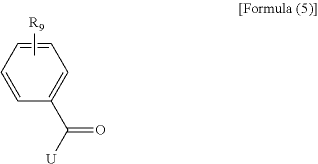
in Formula (5), R₉ represents a hydrogen atom, a halogen atom, a nitro group, an acyl group optionally having a substituent, an alkyl group having from 1 to 20 carbons and optionally having a substituent, or an aryl group optionally having a substituent; when two or more Ros are present, they may be bonded together and have a cyclic structure; and U represents a bond with nitrogen to which R₃ is bonded or with carbon to which any of R₄, R₅, R₆, and R₇ is bonded.

7. The electrophotographic photoreceptor according to claim 1, wherein the protective layer has a chain-polymerizable functional group.

8. The electrophotographic photoreceptor according to claim 7, wherein the chain-polymerizable functional group is an acryloyloxy group or a methacryloyloxy group.

9. The electrophotographic photoreceptor according to claim 6, wherein R₆ is the structure represented by Formula (5).

10. The electrophotographic photoreceptor according to claim 1, wherein the organic group of R₁ is an acyl group optionally having a substituent, an alkyl group optionally having a substituent, or an aryl group optionally having a substituent.

11. The electrophotographic photoreceptor according to claim 1, wherein R₁ is one structure selected from the group consisting of structures represented by Formulae (6) to (8) described below: 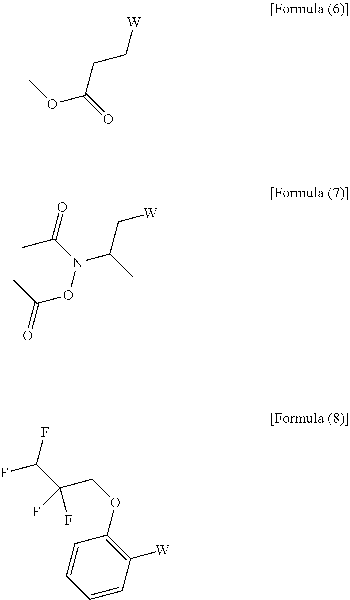
in Formula (6), Formula (7), and Formula (8), W represents a bond with carbon to which R₁ is bonded.

12. The electrophotographic photoreceptor according to claim 1, wherein R₃ is an alkyl group having from 1 to 20 carbons and optionally having a substituent.

13. The electrophotographic photoreceptor according to claim 1, wherein the protective layer contains metal oxide particles.

14. The electrophotographic photoreceptor according to claim 13, wherein the metal oxide particles are titanium oxide.

15. The electrophotographic photoreceptor according to claim 13, wherein the protective layer contains the structure represented by Formula (1) or the structure represented by Formula (3) in a proportion of 0.03 mol % or more and 2 mol % or less per 100 mol % of the metal oxide particles in the protective layer.

16. The electrophotographic photoreceptor according to claim 1, wherein the photosensitive layer is a single-layer type photosensitive layer.

17. An electrophotographic photoreceptor cartridge comprising the electrophotographic photoreceptor described in claim 1.

18. An image forming apparatus comprising the electrophotographic photoreceptor described in claim 1.
